(19) United States
(12) Patent Application Publication
(10) Pub. No.: US 2014/0335752 A1
(43) Pub. Date: Nov. 13, 2014

(54) Hybrid Composite Structure

(71) Applicant: Innegra Technologies, LLC, Greenville, SC (US)

(72) Inventors: Jeffrey Ettin, Simpsonville, SC (US); Elizabeth Cates, Duncan, SC (US); Brian Morin, Greenville, SC (US)

(21) Appl. No.: 14/445,640

(22) Filed: Jul. 29, 2014

Related U.S. Application Data
(63) Continuation-in-part of application No. 11/438,530, filed on May 22, 2006.
(60) Provisional application No. 61/859,707, filed on Jul. 29, 2013.

(51) Int. Cl. D02G 3/04; B32B 5/26

(52) U.S. Cl. CPC D02G 3/045; B32B 5/26; D10B 2321/02; D10B 2401/063; D10B 2101/00; B32B 2262/14; B32B 2262/12
USPC 442/199; 428/221

(57) ABSTRACT

This invention is a hybrid composite structure comprising: a laminate including two plies of fabric wherein the fabric includes a composite yarn; a first polyolefin yarn included in the composite yarn having about 80% crystallinity according to WAXS measuring techniques; a second yarn physically combined with the first polyolefin yarn and included in the composite yarn; and, wherein the laminate has the physical property of impact energy absorption more than 50% higher than a panel made with an equivalent weight of the second yarn alone as measured by the ASTM D5420 drop-impact testing method.

### CLAIM OF PRIORITY

This application is a Continuation in part of Untied States application Ser. No. 11/438,530 and U.S. Application 61/859,707 that are incorporated herein by reference.

### BACKGROUND OF THE INVENTION

Yarns and fibers formed from polyolefins can offer many desirable characteristics. For example, they can possess good toughness and fatigue resistance, they can be resistant to chemical and biological degradation, and the raw materials are readily available. As such, monofilament fibers as well as multifilament yarns have been formed from various polyolefins such as polypropylene. More recently, multifilament polyolefin fibers with high tenacity and modulus have been developed. However, these high-tenacity and high-modulus polyolefin multifilament yarns have seen little application in the field of fiber-reinforced composites, due largely to the difficulty in combining these yarns with other high-modulus reinforcing fibers. As such, there remains room for improvement and variation within the art.

### SUMMARY OF THE INVENTION

In one embodiment, a hybrid composite structure comprising: a laminate including two plies of fabric wherein the fabric includes a composite yarn; a first polyolefin yarn included in the composite yarn having about 80% crystallinity according to WAXS measuring techniques; a second yarn physically combined with the first polyolefin yarn and included in the composite yarn; and, wherein the laminate has the physical property of impact energy absorption more than 50% higher than a panel made with an equivalent weight of the second yarn alone as measured by the ASTM D5420 drop-impact testing method.

The second yarn can be taken from the group consisting of glass; quartz; carbon; poly(p-phenylene terephthalamide), poly(m-phenylene terephthalamide); poly(vinyl alcohol); poly(1,4-phenylene-2,14-benzibisoxazole) (PBO); poly(1,4-phenylene-2,14-benzobisthiazole) (PBT); poly(benzimidizole) (PBI); poly(ethylene-2,14-naphthalate) (PEN); lyotropic liquid crystalline polymers formed by polycondensation of aromatic organic monomers to form aromatic polyesters, polyamides, aluminia-silicates, basalt, regenerated cellulosic materials and ultra-high molecular weight polyethylene (UHMWPE).

The composite yarn can have at least one of the following properties: tenacity greater than about 100% of the expected tenacity based on the volume fraction of the second; an initial modulus greater than about 100% of the expected modulus based on the volume fraction of the second; elongation at break less than about 320% of the elongation at break of the second. One ply can be woven fabric. One ply can be of a different material from that of the other ply. A binding agent can be placed between the plies.

The first polyolefin yarn is included in the composite yarn of at least one ply in the range of 26% to 51% by weight. Filaments can be included in the first polyolefin yarn; and, a plurality of microfibrils can be included in at least one of the filaments wherein the filament includes a plurality of voids interspersed within the microfibrils, wherein both said microfibrils and voids are aligned substantially parallel to the longitudinal axis of the first polyolefin yarn.

The first polyolefin yarn is a blend of a first polyolefin and a second polymer taken from the group consisting of: thermoplastic, thermoset, and non-olefinic polymer. The first polyolefin yarn can be polypropylene. The laminate can be in an arrangement taken from the group of solid laminates, hollow laminates, tubular laminates, panel structure,

### BRIEF DESCRIPTION OF THE FIGURES

A full and enabling disclosure of the present invention, including the best mode thereof, to one of ordinary skill in the art, is set forth more particularly in the remainder of the specification, including reference to the accompanying Figures in which:

FIG. 1 illustrates one embodiment of a process according to the present invention;

FIG. 2 illustrates the die swell of a single filament formed according to one embodiment of the present invention;

FIG. 3 is the WAXS scattering pattern of a polypropylene filament pulled from a multifilament yarn formed according to one embodiment of the presently disclosed processes;

FIG. 4 is the SAXS scattering pattern of the polypropylene filament of FIG. 3;

FIG. 5. is a graphical representation of physical properties and aspects of the present invention; and,

FIGS. 6-7 are tables of physical characteristics of the present invention.

Repeat use of reference characters in the present specification and drawings is intended to represent the same or analogous features or elements of the present invention.

### DETAILED DESCRIPTION OF THE INVENTION

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used in another embodiment to yield a still further embodiment. Thus, it is intended that the present invention cover such modifications and variations as come within the scope of the appended claims and their equivalents.

In general, the present invention is directed to multifilament polyolefin yarns and methods suitable for forming the disclosed multifilament polyolefin yarns. Beneficially, the disclosed methods can be utilized to form multifilament polyolefin yarns that can exhibit at least one of higher modulus or higher tenacity as compared to previously known multifilament polyolefin yarns.

The methods of the disclosed invention are generally directed to a melt-spinning yarn formation process. More particularly, the process utilized in forming the disclosed yarns can include forming a molten composition including a polyolefin, extruding multiple (i.e., at least three) individual filaments of the composition at a relatively low spinning rate, quenching the filaments in a liquid, forming a yarn structure of the multiple individual filaments, and mechanically drawing the yarn structure while the structure is heated.

In one particular embodiment, the polyolefin utilized in forming the disclosed yarns can be a polypropylene. This is not a requirement of the present invention, however, and though the ensuing discussion is generally directed toward polypropylene, it should be understood that other polyolefins can optionally be utilized in the invention. For example, in one embodiment, the disclosed invention can be directed to the formation of polyethylene, polybutylene or poly-4-methylpentene multifilament yarn.

In addition, and for purposes of this disclosure, the term polypropylene is intended to include any polymeric composition comprising propylene monomers, either alone (i.e., homopolymer) or in mixture or copolymer with other polyolefins, dienes, or other monomers (such as ethylene, butylene, and the like). The term is also intended to encompass any different configuration and arrangement of the constituent monomers (such as syndiotactic, isotactic, and the like). Thus, the term as applied to fibers is intended to encompass actual long strands, tapes, threads, and the like, of drawn polymer.

For purposes of this disclosure, the terms fiber and yarn are intended to encompass structures that exhibit a length that far exceeds their largest cross-sectional dimension (such as, for example, the diameter for round fibers). Thus, the term fiber as utilized herein differs from structures such as plaques, containers, sheets, and the like that are blow-molded or injection molded. Moreover, the term multifilament yarn is intended to encompass a structure that includes at least three filaments that have been individually formed such as, for example, via extrusion through a spinneret, prior to being brought in proximity to one another to form a single yarn structure.

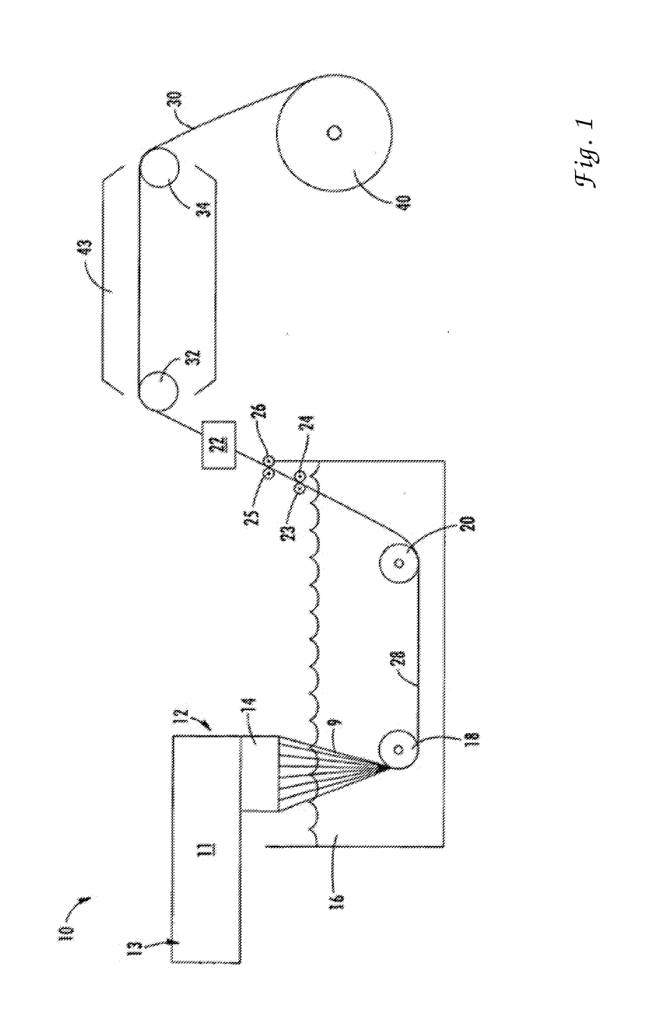

One embodiment of the presently disclosed process generally 10 is schematically illustrated in FIG. 1. According to the illustrated embodiment, a polymeric composition can be provided to an extruder apparatus 12. For example, in one embodiment, the polymeric composition can include polypropylene.

Generally, any polypropylene suitable for forming drawn yarn can be utilized in the disclosed process. For instance, polypropylene suitable for the present invention can generally be of any standard melt flow. For example, in one embodiment, standard extrusion grade polypropylene resin possessing ranges of melt flow indices (MFI) between about 0.2 and about 50 can be utilized in forming the disclosed multifilament yarns. In one embodiment, polypropylene possessing an MFI between about 0.5 and about 25 can be utilized. In one embodiment, the polypropylene utilized in forming the multifilament yarn can have an MFI between about 1 and about 15.

In one embodiment, the polymeric composition provided to the extruder apparatus 12 can include polypropylene and a nucleating agent. According to this embodiment, the nucleating agent can generally be any material that can provide nucleation sites for the polypropylene crystals that can form during the transition of the polypropylene from the molten state to the solid structure. In one embodiment, the nucleating agent can exhibit high solubility in the polypropylene, though this is not a requirement of the invention. The nucleating agent may be an inorganic compound or an organic compound. A non-limiting list of exemplary nucleating agents can include, for example, dibenzylidene sorbitol nucleating agents, as are generally known in the art, such as dibenzylidene sorbitol (DBS), monomethyldibenzylidene sorbitols such as 1,3:2,4-bis(p-methylbenzylidene) sorbitol (p-MDBS), dimethyl dibenzylidene sorbitols such as 1,3:2,4-bis(3,4-dimethylbenzylidene) sorbitol (3,4-DMDBS), and the like. Other suitable nucleating agents can include sodium benzoate, phosphate ester salts, such as NA-11 and NA-21, developed by Asahi Denka of Japan, or the carboxylate salt-type hyper nucleating agents developed by Milliken Chemical of South Carolina such as, for example, Hyperform® HPN-68L, as described in the U.S. Pat. Nos. 6,465,551, 6,599,968, and 7,566,797.

According to the disclosed process, the polymeric composition, which can, in one embodiment include polypropylene combined with a nucleating agent, can be provided to an extruder apparatus 12. In this particular embodiment, the polypropylene component and the nucleating agent can be provided to the extruder apparatus 12 either separately or together, as at an inlet 13. For example, polypropylene and a nucleating agent can be provided to the extruder 12 either separately or together in liquid, powder, or pellet form. For instance, in one embodiment, both the polypropylene and the nucleating agent can be provided to the extruder 12 in pellet form at inlet 13. In another embodiment, the nucleating agent can be provided to the extruder apparatus 12 in a liquid form. For example, nucleating agents in a liquid form such as those disclosed in U.S. Pat. No. 6,102,999 to Cobb, III, et al., which is incorporated herein by reference, can be utilized in the process.

When included, the nucleating agent can generally be present in the mixture to be extruded in an amount less than about 1% by weight of the composition. For example, the nucleating agent can be present in the mixture in an amount less than about 0.5% by weight. In one embodiment, the nucleating agent can be present in the mixture in an amount between about 0.01% by weight and about 0.3% by weight. In another embodiment, the nucleating can be present in the mixture in an amount between about 0.05% by weight and about 0.25% by weight.

The mixture including the polypropylene and, optionally, the nucleating agent can also include various other additives as are generally known in the art. For example, in one embodiment, the disclosed multifilament yarn can be colored yarn, and the mixture can include suitable coloring agents, such as dyes or other pigments. According to this embodiment, it may be preferable to utilize a nucleating agent that will not affect the final color of the multi-component yarn, but this is not a requirement of the invention, and in other embodiments, nucleating agents can be utilized that enhance or otherwise affect the color of the formed yarn. Other additives that can be combined with the mixture can include, for example, one or more of anti-static agents, antioxidant agents, antimicrobial agents, adhesion-promoting agents, friction-reducing or lubricating agents, stabilizers, plasticizers, brightening compounds, clarifying agents, ultraviolet light stabilizing agents, surface active agents, odor enhancing or preventative agents, light scattering agents, halogen scavengers, and the like. In addition, additives can be included in the melt, or in some embodiments, can be applied as a surface treatment to either the undrawn fiber bundle or optionally to the drawn yarn, as generally known in the art.

In one embodiment, the extruder apparatus 12 can be a melt spinning apparatus as is generally known in the art. For example, the extruder apparatus 12 can include a mixing manifold 11 in which a composition including one or more polyolefins and any other desired additives can be mixed and heated to form a molten composition. The formation of the molten mixture can generally be carried out at a temperature so as to ensure melting of essentially all of the polypropylene. For example, in one embodiment, the mixture can be mixed and melted in a manifold 11 heated to a temperature of between about 175° C. and about 325° C.

Optionally, to help ensure the fluid state of the molten mixture, in one embodiment, the molten mixture can be filtered prior to extrusion. For example, the molten mixture can be filtered to remove any fine particles from the mixture with a filter of between about 180 and about 360 gauge.

Following formation of the molten mixture, the mixture can be conveyed under pressure to the spinneret 14 of the extruder apparatus 12, where it can be extruded through multiple spinneret orifices to form multiple filaments 9. For instance, the spinneret can define at least three spinneret orifices. In one embodiment, the spinneret can define between 4 and about 100,000 individual spinneret orifices. For purposes of this disclosure, the terms extrusion die and spinneret are used herein interchangeably and intended to mean the same thing; the same is true for the terms spinneret orifice, spinneret aperture, extruder orifice and extruder aperture. The spinneret 14 can generally be heated to a temperature that can allow for the extrusion of the molten polymer while preventing breakage of the filaments 9 during formation. For example, in one embodiment, the spinneret 14 can be heated to a temperature of between about 175° C. and about 325° C. In one embodiment, the spinneret 14 can be heated to the same temperature as the mixing manifold 11. This is not a requirement of the process, however, and in other embodiments, the spinneret 14 can be at a different temperature than the mixing manifold 11.

The spinneret orifices through which the polymer can be extruded can generally be less than about 0.1 inches in maximum cross-sectional distance (e.g., diameter in the particular case of a circular orifice). For example, in one embodiment, the spinneret orifices can be between about 0.002 inches and about 0.050 inches in maximum cross-sectional distance.

According to the present invention, the polymer can be extruded through the spinneret at a relatively high throughput. For example, the polymer can be extruded through the spinneret at a throughput of not less than about 50% of that required to give melt fracture. In other words, the throughput can be at least 50% of the throughput at which the molten exudate can become excessively distorted. The specific melt fracture throughput can generally vary depending upon one or more of the exudate material, the total number of apertures in the spinneret, the spinneret aperture size, as well as the exudate temperature. For example, when considering the extrusion of molten polypropylene through a spinneret of 8 round apertures of 0.012-inch diameter each, melt fracture can occur at a pump speed of between about 22 and about 24 revolutions/minute of a 0.160 cm3/rev melt pump, or a throughput of about 5.5-6.0 g/min, when extruding a 4 melt flow homopolymer polypropylene at a spinneret temperature of about 230° C. Specific melt fracture throughput values for any particular system and materials as well as methods of obtaining such are generally known to those of skill in the art, and thus a detailed discussion of this phenomenon is not included herein.

In addition to a relatively high throughput, the filaments can also be formed at a relatively low spinline tension. The combination of high throughput with low spinline tension can allow the filaments to be formed with a relatively low ratio of orifice size to final drawn filament size as compared to other previously known multifilament formation processes. For instance, the ratio of the maximum cross-sectional width of an orifice to the maximum cross-sectional distance of a single fully drawn filament extruded through the orifice can, in one embodiment, be between about 2 and about 10. In one embodiment, this ratio can be between about 3 and about 8. Accordingly, the material forming each filament can be in a fairly relaxed, disorganized state as it begins to cool and crystallize.

Referring again to FIG. 1, following extrusion of the polymer, the undrawn filaments 9 can be quenched in a liquid bath 16 and collected by a take-up roll 18 to form a multifilament fiber structure or fiber bundle 28. While not wishing to be bound by any particular theory, it is believed that by extruding the filaments at a relatively low spinline tension and high throughput combined with quenching the polymeric filaments in a liquid bath, the presently disclosed process encourages the formation of folded chain crystals in a highly disordered state in the polymer, which in turn enables a high draw ratio to be utilized in the process and thereby enables the formation of a multifilament yarn having high tenacity and modulus.

As is generally known in the art, polymers that are crystallized from a melt under dynamic temperature and stress conditions crystallize with the rate of crystallization dependent upon both the number of nucleation sites as well as on the growth rate of the crystals. Moreover, both of these factors are in turn related to the conditions that the polymer is subject to as it is quenched. In addition, polymers that crystallize when in a highly oriented state tend to have limited tenacity and modulus as evidenced by the limited draw ratios possible for such highly oriented polymers. Thus, in order to obtain a multifilament yarn with high tenacity and modulus, i.e., formed with a high draw ratio, crystallization of the polymer while in a highly disordered state is suggested. Accordingly, the present invention discloses a multifilament yarn formation process in which crystallization of the polymer in a highly disordered state is promoted by encouraging the filament to maximize its relaxation into the desired disoriented state during crystallization by forming the polymer at a relatively high throughput and low spinline tension. Optionally, a higher rate of crystallization can also be encouraged in certain embodiments through addition of a nucleating agent to the melt. In addition, quenching the formed polymer filaments in a liquid bath can promote the formation of folded chain crystals, which is also associated with the high draw ratios of high tenacity, high modulus materials.

As described, the individual filaments 9 can be extruded according to the disclosed process at relatively low spinline tension. As such, the take-up roll 18 can operate at a relatively low speed. For example, the take-up roll 18 can generally be set at a speed of less than about 25 meters per minute (m/min). In one embodiment, the take-up roll 18 can be set at a speed of between about 1 m/min and about 20 m/min.

The liquid bath 16 in which the filaments 9 can be quenched can be a liquid in which the polymer is insoluble. For example, the liquid can be water, ethylene glycol, or any other suitable liquid as is generally known in the art. In one embodiment, in order to further encourage the formation of folded chain crystals in the filaments 9, the bath 16 can be heated. For example, the bath can be heated to a temperature near the maximum crystallization temperature (Tc) of the polymer. For example, the bath can be heated to a temperature of between about 50° C. and about 130° C.

Generally, in order to encourage formation of filaments with substantially constant cross-sectional dimensions along the filament length, excessive agitation of the bath 16 can be avoided during the process.

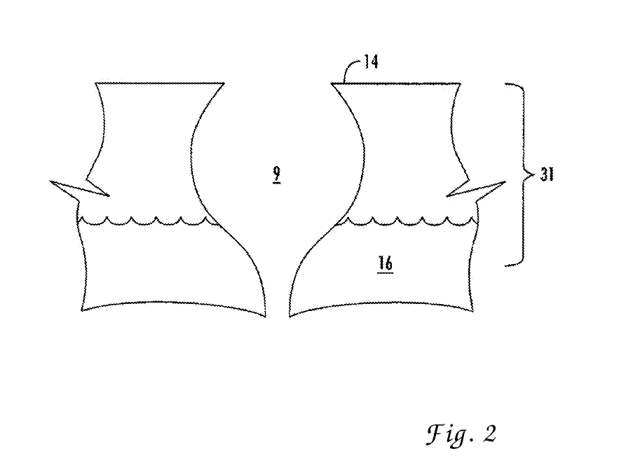

In one embodiment, quenching of the polymer can begin as soon as possible following exit from the spinneret, in order to encourage crystallization of the polymer while in the highly disoriented, relaxed state immediately following extrusion. For example, in one embodiment, the surface of the bath 16 can be located at a minimum distance from the spinneret 14. For instance, in the embodiment illustrated in FIG. 2, the surface of the bath 16 can be at a distance from the spinneret 14 such that an extruded filament 9 can enter the bath 16 within the distance of the die swell 31 of the filament 9. Optionally, the individual filaments 9 can pass through a heated or a non-heated shroud prior to entering the bath 16. For example, a heated shroud may be utilized in those embodiments where the distance between the orifice and the bath surface is greater than the die swell. In one embodiment, the distance between the spinneret and the bath can be less than 2 inches. In another embodiment, this distance can be less than 1 inch.

Take-up roll 18 and roll 20 can be within bath 16 and convey individual filaments 9 and fiber bundle 28 through the bath 16. Dwell time of the material in the bath 16 can vary, depending upon particular materials included in the polymeric material, particular line speed, etc. In general, filaments 9 and subsequently formed fiber bundle 28 can be conveyed through bath 16 with a dwell time long enough so as to ensure complete quench, i.e., crystallization, of the polymeric material. For example, in one embodiment, the dwell time of the material in the bath 16 can be between about 6 seconds and about 1 minute.

At or near the location where the fiber bundle 28 exits the bath 16, excess liquid can be removed from the fiber bundle 28. This step can generally be accomplished according to any process known in the art. For example, in the embodiment illustrated in FIG. 1, the fiber bundle 28 can pass through a series of nip rolls 23, 24, 25, 26 to remove excess liquid from the fiber bundle. Other methods can be alternatively utilized, however. For example, in other embodiments, excess liquid can be removed from the fiber bundle 28 through utilization of a vacuum, a press process utilizing a squeegee, one or more air knives, and the like.

In one embodiment, a lubricant can be applied to the fiber bundle 28. For example, a spin finish can be applied at a spin finish applicator chest 22, as is generally known in the art. In general, a lubricant can be applied to the fiber bundle 28 at a low water content. For example, a lubricant can be applied to the fiber bundle 28 when the fiber bundle is at a water content of less than about 75% by weight. Any suitable lubricant can be applied to the fiber bundle 28. For example, a suitable oil-based finish can be applied to the fiber bundle 28, such as Lurol PP-912, available from Goulston Technologies, Inc. Addition of a finishing or lubricant coat on the yarn can, in some embodiments of the invention, improve handling of the fiber bundle during subsequent processing and can also reduce friction and static electricity build-up on the yarn. In addition, a finish coat on the yarn can improve slip between individual filaments of the yarn during a subsequent drawing process and can increase the attainable draw ratio, and thus increase the modulus and tenacity of the drawn multifilament yarn formed according to the disclosed process.

After quenching of the fiber bundle 28 and any optional process steps, such as addition of a lubricant for example, the fiber bundle can be drawn while applying heat. For example, in the embodiment illustrated in FIG. 1, the fiber bundle 28 can be drawn in an oven 43 heated to a temperature of between about 80° C. and about 170° C. Additionally, in this embodiment, the draw rolls 32, 34 can be either interior or exterior to the oven 43, as is generally known in the art. In another embodiment, rather than utilizing an oven as the heat source, the draw rolls 32, 34 can be heated so as to draw the yarn while it is heated. For example, the draw rolls can be heated to a temperature of between about 80° C. and about 170° C. In another embodiment, the yarn can be drawn over a hotplate heated to a similar temperature (i.e., between about 80° C. and about 170° C.). In one embodiment, the oven, draw rolls, hotplate, or any other suitable source of heat can be heated to a temperature of between about 120° C. and about 150° C.

According to the disclosed process, the multifilament fiber bundle can be drawn in a first (or only) draw at a high draw ratio, higher than those attainable in previously known polyolefin melt-spun multifilament yarn formation processes. For example, the fiber bundle 28 can be drawn with a draw ratio (defined as the ratio of the speed of the second or final draw roll 34 to the first draw roll 32) of greater than about 6. For instance, in one embodiment, the draw ratio of the first (or only) draw can be between about 6 and about 25. In another embodiment, the draw ratio can be greater than about 10, for instance, greater than about 15. Additionally, the yarn can be wrapped on the rolls 32, 34 as is generally known in the art. For example, in one embodiment, between about 5 and about 15 wraps of the yarn can be wrapped on the draw rolls.

While the illustrated embodiment utilizes a series of draw rolls for purposes of drawing the yarn, it should be understood that any suitable process that can place a force on the yarn so as to elongate the yarn following the quenching step can optionally be utilized. For example, any mechanical apparatus including nip rolls, godet rolls, steam cans, air, steam, or other gaseous jets can optionally be utilized to draw the yarn.

According to the embodiment illustrated in FIG. 1, following the yarn drawing step, the multifilament yarn 30 can be cooled and wound on a take-up roll 40. In other embodiments, however, additional processing of the yarn 30 may be carried out. For example, in one embodiment, the multifilament yarn can be subjected to additional drawing steps. In general, subsequent drawing steps can be carried out at a higher temperature than the first draw. For instance, the heating element of a second drawing step can be heated to a temperature between about 10° C. and about 50° C. higher than the heating element of the first drawing step. In addition, a second draw can generally be at a lower drawing ratio that the first draw. For example, a second draw can be carried out at a draw ratio of less than 5. In one embodiment, a second draw can be carried out at a draw ratio of less than 3. In the case of multiple draws, the total draw ratio will be the product of each of the individual draws, thus a yarn first drawn at a draw ratio of 3, and then subsequently drawn at a draw ratio of 2 will have been subjected to a total draw ratio of 6.

Optionally, the drawn multifilament yarn can be heat set. For example, the multifilament yarn can be relaxed or subjected to a very low draw ratio (e.g., a draw ratio of between about 0.7 and about 1.3) and subjected to a temperature of between about 130° C. and about 150° C. for a short period of time, generally less than 3 minutes. In some embodiment, a heat setting step can be less than one minute, for example, about 0.5 seconds. This temperature can generally be higher than the drawing temperature(s). This optional heat set step can serve to “lock” in the crystalline structure of the yarn following drawing. In addition, it can reduce heat shrinkage, which may be desired in some embodiments.

In another embodiment, the finished yarn can be surface treated to improve certain characteristics of the yarn, such as wettability or adhesion, for example. For instance, the yarn can be fibrillated, subjected to plasma or corona treatments, or can include an added surface yarn sizing, all of which are generally known in the art, to improve physical characteristics of the yarns. Beneficially, the multifilament yarns of the invention can have a high surface area available for surface treatments, and thus can exhibit greatly improved characteristics, such as adhesion, as compared to, for instance, monofilament fibers formed of similar materials.

In general, the finished multifilament yarn 30 can be wound on a spool or take-up reel 40, as shown, and transported to a second location for formation of a secondary product. In an alternative embodiment, however, the multifilament yarn can be fed to a second processing line, where the yarn can be further processed to form a secondary product, such as a composite yarn or a woven fabric, for example.

The polyolefin multifilament yarn of the present invention can generally have a drawn size of between about 0.5 denier per filament and about 100 denier per filament. Beneficially, the disclosed multifilament yarn can have a high tenacity and modulus, as measured in ASTM D2256-02, which is incorporated herein by reference, and as compared to other, previously known multifilament polyolefin yarn. For example, the disclosed multifilament yarn can have a tenacity greater than about 5 grams/denier. In one embodiment, the multifilament yarn can have a tenacity greater than about 7 grams/denier. In addition, the multifilament yarn of the present invention can have a high modulus, for example, greater than about 100 grams/denier. In one embodiment, the disclosed yarn can have a modulus greater than about 125 grams/denier, for example, greater than about 150 grams/denier, or greater than about 200 grams/denier.

In addition, the disclosed yarn can exhibit relatively low elongation characteristics. For example, the multifilament yarn of the present invention can exhibit an elongation percentage of less than about 15%, as measured in ASTM D2256-02. In another embodiment, the yarn can exhibit less than about 10% elongation, for example, less than about 8% elongation.

The inventive multifilament yarns are also believed to possess a unique crystalline structure as compared to other, previously known polyolefin multifilament yarns. There are several widely accepted means by which to measure molecular orientation in oriented polymer systems, among them scattering of light or X-rays, absorbance measurements, mechanical property analysis, and the like. Quantitative methods include wide angle X-ray scattering (WAXS), and small angle X-ray scattering (SAXS).

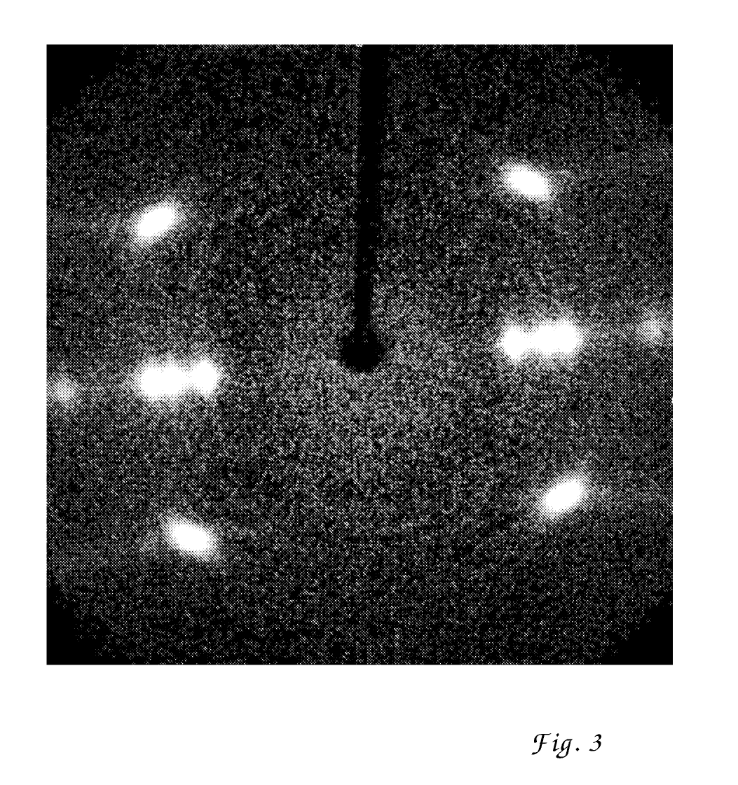

Through the utilization of WAXS and SAXS techniques, the disclosed multifilament yarns can be shown to be highly crystalline, highly oriented, with little or no lamellar structure. In particular, the filaments of the yarns can possess greater than about 80% crystallinity according to WAXS measuring techniques described below. For example, FIG. 3 illustrates the WAXS scattering pattern of a single filament pulled from a multifilament yarn formed according to the presently disclosed process. In particular, the yarn (listed as sample Q in the Example section, below) was extruded through a spinneret with eight orifices of 0.012 inches diameter each, quenched in a water bath at 73° C., and drawn at a draw ratio of 16.2. The drawn yarn had a final denier of 406 grams/9000 m. As can be seen with reference to the Figure, where 0φ is parallel to the yarn, the amorphous region of the disclosed yarns can be 2θ from 10 to 30 and φ from 60 to 90 (the dark region near bottom of FIG. 3), and the crystalline region can be 2θ from 10 to 30 and φ from −15 to 15 (including bright spots on the sides of FIG. 3). Thus by integrating the x-ray scattering intensity in the crystalline and amorphous regions, the crystallinity of the filament can be obtained as

$$\frac{( {I}_{X} - {I}_{A} )}{( {I}_{X} )}$$

where:

I_{X} is the intensity in the crystalline region and

I_{A} is the intensity in the amorphous region.

In addition, the polyolefin yarns of the invention can be highly oriented, as shown by the narrow width of the WAXS peaks in FIG. 3.

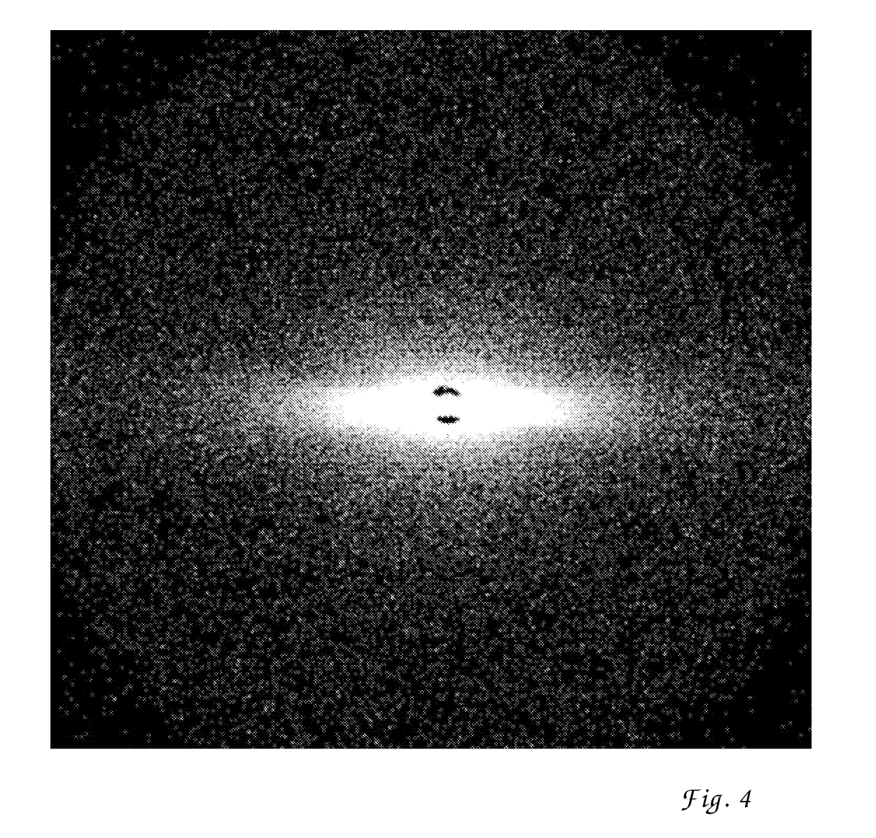

FIG. 4 is the SAXS pattern of the filament shown in FIG. 3. Surprisingly, none of the expected structures relating to the crystalline form, orientation, and amorphous regions appear in the Figure, and the yarn appears to have no true amorphous regions at all, but appears to be composed entirely of crystalline regions and highly oriented amorphous regions.

SAXS patterns of multifilament yarns formed according to previously know methods generally include alternating crystalline and amorphous regions as illustrated by bright spots of scattering intensity in the yarn axis. (See, for example, Polypropylene Fibers—Science and Technology, M. Ahmed, Elsevier Scientific Publishing Company, 1982, pp. 192-203, which is incorporated herein by reference.) The positions of these spots can be utilized to obtain the long period spacing between repeating crystalline regions. The absence of these spots in FIG. 4 indicates that any amorphous regions in the inventive yarn of FIG. 4 have nearly identical electron density to the crystalline regions, and are thus composed of dense, highly oriented amorphous chains, or are absent altogether. When combined with the WAXS pattern of FIG. 3, which indicates that the amorphous intensity is at least 15%, it may be assumed that amorphous regions of the illustrated filament most likely consists of the highly oriented chains.

In addition, the equatorial scattering in SAXS patterns in general arises from the center normal to the fiber axis and projects in a long, thin streak away from the center in each direction. In the inventive yarns, and in further reference to FIG. 4, these equatorial scattering streaks have amplified greatly, to the point that they are more aptly described as “wings.” This equatorial scattering arises from fibrillation of the crystalline segments into more clearly defined needle-like assemblies. A long equatorial streak arises from a high concentration of cylindrical, shish-type structures in the yarn with the lamellae organized among or around the shishes, as “kabobs.” These streaks generally appear in higher draw situations such as those of the present invention.

As can also be seen in FIG. 4, the filaments forming the yarns of the present invention under high draw conditions can describe a nearly absent meridonal reflection and an equatorial scattering that is strong such that the scattering ratio of equatorial to meridional scattering intensity is high, but there remains strong density contrast as indicated by the overall intensity.

In general, the filaments forming the multifilament yarns of the present invention can have SAXS characteristics including a ratio of equatorial intensity to meridonal intensity of greater than about 1.0. In one embodiment, this ratio can be greater than about 3. The filaments forming the disclosed yarns can generally exhibit an equatorial intensity integrated from 28 of between about 0.4 to about 1.0 and φ from about 60 to about 120 and from about 240 to about 300 (zero φ being parallel to the yarn, or vertical in reference to FIG. 4). In addition, the yarns can exhibit a meridonal intensity integrated from 2θ of between about 0.4 and about 1.0 and φ from about −60 to about 60 and from about 120 to about 240.

The disclosed multifilament polyolefin yarns can be beneficially utilized in many applications. For example, the high strength and high tenacity of the disclosed yarns can provide them with excellent qualities for utilization in any application suitable for previously known multifilament polyolefin yarns. For example, in certain embodiments, the disclosed yarns can be beneficially utilized as reinforcement material in a matrix. For example, in one embodiment, following formation of the multifilament drawn yarn according to the disclosed processes, the yarn can be further processed so as to be suitable for use as a reinforcement material in a matrix. For Instance, the multifilament yarns of the present invention can be chopped, fibrillated, flattened or otherwise deformed as is generally known in the art. As the multifilament yarns are processed in order to form the disclosed reinforcement materials, the multifilament yarns can not only be shortened, deformed, abraded, and the like, but in addition, the multifilament yarns can become shredded. That is, during processing, individual filaments of the yarns can become separated from one another in forming the disclosed reinforcement materials.

In one embodiment of the present invention, the disclosed yarns can be further processed if necessary and utilized in forming secondary products including those products that in the past have been formed with previously known multifilament polyolefin yarns. For example, the disclosed yarns can be utilized in forming ropes, and woven or nonwoven fabrics such as may be found in machinery belts or hoses, roofing fabrics, geotextiles, and the like. In particular, the disclosed multifilament yarns can be suitable for use in forming a secondary product according to any known technique that has been used in the past with previously known polyolefin multifilament yarns. Due to the improved physical properties of the disclosed yarns, however, and particularly, the higher modulus and tenacity of the disclosed yarns, secondary products formed utilizing the inventive yarns can provide improved characteristics, such as strength and tenacity, as compared to similar products formed of previously known multifilament polyolefin yarns. The invention may be better understood with reference to the following Example.

### EXAMPLE

Yarn samples were formed on system similar to that illustrated in FIG. 1. In particular, the system included a ¾ inch, 24:1 single screw extruder with three temperature zones, a head with a melt pump and spinneret, a liquid quench tank (40 inch length), with two rollers in the tank, a vacuum water removal system, a spin finish applicator, three heated godet rolls, a forced air oven (120 inch length) and a Leesona® winder.

Materials utilized in forming the yarns included Atofina® 3462, a polypropylene homopolymer with a melt flow index of 3.7 and Atofina® 3281, a polypropylene homopolymer with a melt flow index of 1.3 (both available from ATOFINA Petrochemicals, Inc. of Houston, Tex.), a 10% concentrate of a nucleating agent composition, specifically Millad® 3988 (3,4-dimethyl dibenzylidiene sorbitol) in a 12 MFI polypropylene homopolymer (available from Standridge Color Corporation, Social Circle, Ga., USA), and a polyethylene homopolymer with a melt flow index of 12 (available from TDL Plastics, of Houston, Tex.).

Table 1, below, tabulates the formation conditions of 37 different samples including the material make-up (including the polymer used and the total weight percent of the nucleating agent in the melt), the spinneret hole size in inches, the total number of filaments extruded, the temperature of the quench water bath, the roll speeds of the drawing rolls, the total draw ratio (Roll 3/Roll 1), and the temperature of the drawing oven. In addition, as the nucleating agent is provided in a 10% concentrate composition of the nucleating agent in a 12 MFI polypropylene homopolymer, the material make-up of those samples that include an amount of a nucleating agent will also include an amount of the 12 MFI polypropylene homopolymer from the concentrate. For example, a sample that is listed as containing FINA 3462/0.2% Millad will contain 0.2 wt % of the nucleating agent, 1.8 wt % of the 12 MFI polypropylene homopolymer used in forming the 10% nucleating agent composition, and 98 wt % of the FINA 3462 3.7 MFI polypropylene homopolymer.

TABLE 1

| | | Spinneret | # | Water | | | | | Oven |
|---|---|---|---|---|---|---|---|---|---|
| | | Hole Size | Fils | Temp | Roll 1 | Roll 2 | Roll 3 | | T |
| Sample | Material | inches | # | C. | m/min | m/min | m/min | DR | ° C. |
| A | Fina 3462 | 0.04 | 1 | 25 | 11.3 | 100 | 110 | 97 | 120 |
| B | Fina 3462/0.2% Millad | 0.04 | 1 | 25 | 8 | 123 | 123 | 15.4 | 140 |
| C | Fina 3462/0.2% Millad | 0.027 | 17 | 25 | 5 | 30 | 30 | 6.0 | 120 |
| D | Fina 3462/0.2% Millad | 0.027 | 17 | 25 | 5 | 37.5 | 37.5 | 7.5 | 150 |
| E | Fina 3462/0.25% Millad | 0.018 | 1 | 25 | 10.5 | 135 | 135 | 12.9 | 130 |
| F | Fina 3462/0.25% Millad | 0.018 | 8 | 25 | 9 | 85 | 85 | 9.4 | 130 |
| G | Fina 3462/0.25% Millad | 0.018 | 8 | 25 | 6 | 85 | 85 | 14.2 | 130 |
| H | Fina 3462/0.25% Millad | 0.012 | 8 | 25 | 8.75 | 85 | 85 | 9.7 | 130 |
| I | Fina 3462/0.25% Millad | 0.012 | 8 | 25 | 9.5 | 85 | 85 | 8.9 | 130 |
| J | Fina 3462/0.20% Millad | 0.012 | 8 | 25 | 8 | 85 | 85 | 10.6 | 130 |
| K | Fina 3462/0.20% Millad | 0.012 | 8 | 25 | 6.25 | 85 | 85 | 13.6 | 130 |
| L | Fina 3462/0.20% Millad | 0.012 | 8 | 25 | 5.5 | 85 | 85 | 15.5 | 130 |
| M | Fina 3462/0.20% Millad | 0.012 | 8 | 25 | 5.5 | 85 | 85 | 15.5 | 130 |
| N | Fina 3462/0.20% Millad | 0.012 | 5 | 25 | 5 | 85 | 85 | 17.0 | 130 |
| O | Fina 3462/0.20% Millad | 0.012 | 5 | 55 | 6 | 85 | 85 | 14.2 | 130 |
| P | Fina 3462/0.20% Millad | 0.012 | 5 | 55 | 6 | 85 | 85 | 14.2 | 130 |
| Q | Fina 3462/0.20% Millad | 0.012 | 8 | 73 | 5.25 | 84 | 85 | 16.2 | 130 |
| R | Fina 3462/0.20% Millad | 0.012 | 8 | 85 | 5.5 | 84 | 85 | 15.5 | 130 |
| S | Fina 3462/0.20% Millad | 0.012 | 8 | 85 | 5.25 | 84 | 85 | 16.2 | 130 |
| T | Fina 3462/0.20% Millad | 0.012 | 8 | 82 | 4.75 | 84 | 85 | 17.9 | 145 |
| U | Fina 3462/0.20% Millad | 0.012 | 8 | 82 | 4.6 | 84 | 85 | 18.5 | 150 |
| V | Fina 3281/0.2% Millad | 0.012 | 8 | 75 | 4.5 | 84 | 85 | 18.9 | 140 |
| W | Fina 3281/0.2% Millad | 0.012 | 8 | 75 | 4.5 | 84 | 85 | 18.9 | 140 |
| X | Fina 3281 | 0.012 | 8 | 75 | 6 | 84 | 85 | 14.2 | 130 |
| Y | Fina 3281 | 0.012 | 8 | 75 | 4.5 | 84 | 85 | 18.9 | 140 |
| Z | Fina 3281 | 0.012 | 8 | 75 | 4.25 | 84 | 85 | 20.0 | 140 |
| AA | Fina 3281 w/5% 12 MFI PE | 0.012 | 8 | 75 | 5 | 84 | 85 | 17.0 | 130 |
| BB | Fina 3281/0.2% Millad | 0.012 | 8 | 75 | 4.75 | 84 | 85 | 17.9 | 150 |
| CC | Fina 3281/0.2% Millad | 0.012 | 8 | 75 | 4.25 | 84 | 85 | 20.0 | 140 |
| DD | Fina 3281/0.2% Millad | 0.012 | 8 | 75 | 4 | 84 | 85 | 21.3 | 140 |
| EE | Fina 3281/0.2% Millad | 0.012 | 8 | 75 | 4 | 84 | 85 | 21.3 | 140 |
| FF | Fina 3281/0.2% Millad | 0.012 | 8 | 75 | 4 | 84 | 85 | 21.3 | 140 |
| GG | Fina 3281/0.2% Millad | 0.012 | 8 | 75 | 5 | 84 | 85 | 17.0 | 140 |
| HH | Fina 3281/0.2% Millad | 0.012 | 8 | 75 | 4.75 | 84 | 85 | 17.9 | 140 |
| II | Fina 3281/0.2% Millad | 0.008 | 20 | 75 | 4.25 | 84 | 85 | 20.0 | 140 |
| JJ | Fina 3281/0.2% Millad | 0.008 | 20 | 75 | 5.5 | 84 | 85 | 15.5 | 150 |
| KK | Fina 3281/0.2% Millad | 0.008 | 20 | 75 | 4.25 | 84 | 85 | 20.0 | 140 |

Following formation, the samples were tested for a number of physical properties including denier, denier per filament, elongation, tenacity, modulus, and toughness, all according to ASTM D2256-02, previously incorporated by reference. Results are shown below in Table 2.

TABLE 2

| | | Denier | Den/fil | Elong | Ten | Mod | Tuff |
|---|---|---|---|---|---|---|---|
| Sample | Material | g/9000 m | g/9000 m | % | g/d | g/d | g/d |
| A | Fina 3462 | 302 | 302 | 24 | 5.2 | 60 | |
| B | Fina 3462/0.2% Millad | 292 | 292 | 8 | 5.9 | 107 | |
| C | Fina 3462/0.2% Millad | 1300 | 76 | 21 | 5.5 | 50 | |
| D | Fina 3462/0.2% Millad | 1414 | 83 | 16 | 4.2 | 43 | |
| E | Fina 3462/0.25% Millad | 63 | 63 | 10 | 7.9 | 125 | |
| F | Fina 3462/0.25% Millad | 293 | 37 | 22 | 8.5 | | |
| G | Fina 3462/0.25% Millad | 532 | 67 | 11.7 | 10.4 | 173 | |
| H | Fina 3462/0.25% Millad | 210 | 26 | 16.9 | 8.1 | 100 | |
| I | Fina 3462/0.25% Millad | 161 | 20 | 14.8 | 7.2 | 100 | |
| J | Fina 3462/0.20% Millad | 222 | 28 | 15.0 | 9.0 | 108 | |
| K | Fina 3462/0.20% Millad | 316 | 40 | 9.1 | 8.4 | 154 | |
| L | Fina 3462/0.20% Millad | 362 | 45 | 8.9 | 8.8 | 159 | |
| M | Fina 3462/0.20% Millad | 420 | 53 | 11.2 | 9.6 | 146 | |
| N | Fina 3462/0.20% Millad | 297 | 59 | 10.4 | 10.5 | 171 | |
| O | Fina 3462/0.20% Millad | 287 | 57 | 11.3 | 9.4 | 144 | |
| P | Fina 3462/0.20% Millad | 276 | 55 | 9.2 | 7.7 | 132 | |
| Q | Fina 3462/0.20% Millad | 406 | 51 | 9.3 | 11.6 | 207 | |
| R | Fina 3462/0.20% Millad | 369 | 46 | 14.0 | 8.2 | | |
| S | Fina 3462/0.20% Millad | 390 | 49 | 14.0 | 8.4 | | |
| T | Fina 3462/0.20% Millad | 345 | 43 | 9.3 | 10.4 | 189 | |
| U | Fina 3462/0.20% Millad | 324 | 41 | 8.8 | 10.9 | 201 | |
| V | Fina 3281/0.2% Millad | 353 | 44 | 7.3 | 9.3 | 185 | |
| W | Fina 3281/0.2% Millad | 358 | 45 | 6.9 | 9.7 | 203 | |
| X | Fina 3281 | 329 | 41 | 12.5 | 9.3 | 131 | 0.75 |
| Y | Fina 3281 | 301 | 38 | 10.7 | 10.3 | 160 | 0.73 |
| Z | Fina 3281 | 316 | 40 | 9.7 | 9.8 | 165 | 0.66 |
| AA | Fina 3281 w/5% 12 MFI PE | 328 | 41 | 14.0 | 8.9 | | |
| BB | Fina 3281/0.2% Millad | 270 | 34 | 9.1 | 8.5 | 159 | 0.62 |
| CC | Fina 3281/0.2% Millad | 287 | 36 | 8.6 | 8.9 | 181 | 0.58 |
| DD | Fina 3281/0.2% Millad | 265 | 33 | 8.9 | 10.4 | 203 | 0.68 |
| BE | Fina 3281/0.2% Millad | 364 | 46 | 8.1 | 9.1 | 178 | 0.61 |
| FF | Fina 3281/0.2% Millad | 403 | 50 | 6.5 | 8.5 | 181 | 0.41 |
| GG | Fina 3281/0.2% Millad | 356 | 45 | 8.4 | 10.3 | 200 | 0.60 |
| HH | Fina 3281/0.2% Millad | 375 | 47 | 5.3 | 8.8 | 203 | 0.39 |
| II | Fina 3281/0.2% Millad | 396 | 20 | 6.4 | 8.3 | 178 | 0.46 |
| JJ | Fina 3281/0.2% Millad | 589 | 29 | 9.6 | 9.2 | 166 | 0.65 |
| KK | Fina 3281/0.2% Millad | 423 | 21 | 6.1 | 7.8 | 178 | 0.47 |

X-Ray Scattering Analysis

The samples were studied by small angle x-ray scattering (SAXS). The SAXS data were collected on a Bruker AXS (Madison, Wis.) Hi-Star multi-wire detector placed at a distance of 105.45 cm from the sample in an Anton-Paar vacuum. X-rays (λ=0.154178 nm) were generated with a MacScience rotating anode (40 kV, 40 mA) and focused through three pinholes to a size of 0.2 mm. The entire system (generator, detector, beampath, sample holder, and software) is commercially available as a single unit from Bruker AXS. The detector was calibrated per manufacturer recommendation using a sample of silver behenate.

A typical SAXS data collection was conducted as follows: A polypropylene filament bundle was wrapped around a holder, which was placed in the x-ray beam inside an Anton-Paar vacuum sample chamber on the x-ray equipment. The sample chamber and beam path was evacuated to less than 100 mTorr and the sample was exposed to the X-ray beam for between about 45 minutes and one hour. Two-dimensional data frames were collected by the detector and unwarped automatically by the system software.

An analysis of the scattered intensity distribution)(2θ=0.2°−2.5° into the equatorial or meridonal directions was calculated from the raw data frames by dividing the scattering into 2 regions: an equatorial scattering region, integrated from 2θ of between about 0.4 to about 1.0 and φ from about 60 to about 120 and from about 240 to about 300 (zero φ being parallel to the yarn, or vertical in FIG. 4), and the meridonal scattering region, integrated from 2θ of between about 0.4 and about 1.0 and φ from about −60 to about 60 and from about 120 to about 240. Total counts were summed for each of the two regions and the ratio calculated and tabulated for each sample in Table 3, below.

TABLE 3

| | | Meridional | Equatorial | |
|---|---|---|---|---|
| | | Scattering | Scattering | Equatorial/ |
| Sample | Material | counts | counts | Meridional |
| A | Fina 3462 | 150499 | 18174 | 0.12 |
| B | Fina 3462/0.2% Millad | 83716 | 293818 | 3.51 |
| C | Fina 3462/0.2% Millad | 125348 | 20722 | 0.17 |
| D | Fina 3462/0.2% Millad | 169657 | 37642 | 0.22 |
| E | Fina 3462/0.25% Millad | 57067 | 265606 | 4.65 |
| F | Fina 3462/0.25% Millad | 28192 | 23494 | 0.83 |
| G | Fina 3462/0.25% Millad | 34164 | 182207 | 5.33 |
| H | Fina 3462/0.25% Millad | 14203 | 11505 | 0.81 |
| I | Fina 3462/0.25% Millad | 21722 | 17758 | 0.82 |
| J | Fina 3462/0.20% Millad | 36264 | 74971 | 2.07 |
| K | Fina 3462/0.20% Millad | 82734 | 662846 | 8.01 |
| L | Fina 3462/0.20% Millad | 47815 | 175599 | 3.67 |
| M | Fina 3462/0.20% Millad | 53247 | 323136 | 6.07 |
| N | Fina 3462/0.20% Millad | 89254 | 561719 | 6.29 |
| O | Fina 3462/0.20% Millad | 52212 | 313477 | 6.00 |
| P | Fina 3462/0.20% Millad | 57344 | 365467 | 6.37 |
| Q | Fina 3462/0.20% Millad | 107220 | 401479 | 3.74 |
| R | Fina 3462/0.20% Millad | 40419 | 59163 | 1.46 |
| S | Fina 3462/0.20% Millad | 48712 | 106876 | 2.19 |
| T | Fina 3462/0.20% Millad | 49098 | 153474 | 3.13 |
| U | Fina 3462/0.20% Millad | 65459 | 210907 | 3.22 |
| V | Fina 3281/0.2% Millad | 54222 | 220056 | 4.06 |
| W | Fina 3281/0.2% Millad | 43058 | 257097 | 5.97 |
| X | Fina 3281 | 53060 | 159811 | 3.01 |
| Y | Fina 3281 | 57218 | 210415 | 3.68 |
| Z | Fina 3281 | 45224 | 186045 | 4.11 |
| AA | Fina 3281 w/5% 12 MFI PE | 35826 | 87938 | 2.45 |
| BB | Fina 3281/0.2% Millad | 37907 | 98972 | 2.61 |
| CC | Fina 3281/0.2% Millad | 54109 | 164494 | 3.04 |
| DD | Fina 3281/0.2% Millad | 47656 | 202256 | 4.24 |
| EE | Fina 3281/0.2% Millad | 51026 | 171581 | 3.36 |
| FF | Fina 3281/0.2% Millad | 48872 | 181346 | 3.71 |
| GG | Fina 3281/0.2% Millad | 49382 | 282585 | 5.72 |
| HH | Fina 3281/0.2% Millad | 54467 | 348671 | 6.40 |
| II | Fina 3281/0.2% Millad | 57703 | 260487 | 4.51 |
| JJ | Fina 3281/0.2% Millad | 52353 | 178923 | 3.42 |
| KK | Fina 3281/0.2% Millad | 46881 | 203281 | 4.34 |

As can be seen with reference to Table 3, while the disclosed materials can in some cases give to rise to a SAXS scattering profile with both meridonal scattering and equatorial scattering, the meridional scattering is low compared to the highly unique strong equatorial scattering giving rise to a high ratio of equatorial scattering to meridional scattering. At the very least, then, the presence of intense scattering wings in the equatorial direction provides the desired crystal structures that impart the properties of high tenacity and high modulus found in the multifilament yarns.

In one embodiment, a composite can include layers wherein a layer is comprised of high modulus polypropylene fibers as a component of a composite yarn. A composite yarn is herein defined to encompass a yarn formed from the combination of two or more different fiber types. For example, a high modulus polypropylene fiber can be combined with a fiber of a different material such as, but not limited to, glass fibers, carbon fibers, metal fibers, or fibers formed of other polymers such as, for instance, high performance polyolefins such as ultra-high molecular weight polyethylene (UHMWPE), fluorocarbon-based fibers such as polytetrafluororethylene (PTFE), or polyaramids such as poly-paraphenylene terephthalamide to form a composite yarn.

Exemplary composite yarns can be formed according to any suitable composite yarn-forming process. For example, two or more yarns can be combined via twisting, false-twist texturing, air texturing, or any other yarn texturing or combining process. In one embodiment, a composite yarn can be formed including an inner core formed of a first material and an outer wrapping comprising a different material, and in one particular embodiment, a high modulus polypropylene fiber as herein described. One exemplary method for forming such composite yarns has been described in U.S. Pat. No. 6,701,703 to Patrick, which is incorporated herein by reference. In another embodiment, a composite yarn can be formed according to an air-jet combinatorial method, such as that described in U.S. Pat. No. 6,440,558 to Klaus, et al., which is also incorporated herein by reference. These are merely exemplary methods, however, and multiple such suitable combinatorial processes are well known to one of ordinary skill in the art, and are thus not described at length herein.

In one embodiment, a “hybrid”/composite yarn is formed by combination of a first yarn component with a second yarn component in a suitable combining process to yield a substantially homogeneous blend of the first yarn component and the second yarn component, where the first yarn component and the second yarn component are substantially parallel.

In one embodiment, the first yarn component comprises between 20 weight percent and 80 weight percent of the composite yarn and the second yarn component comprises between 80 weight percent and 20 weight percent of the composite yarn.

In one embodiment, the first yarn component is polyolefin multifilament yarn having at least one of the following physical properties: a melt flow index between about 0.2 and about 50; a denier of less than about 300; each filament can have a denier of between about 0.5 and about 100; a high modulus, for instance greater than 40 g/d. In another embodiment, the yarn can have a modulus greater than 100 g/d, or greater than 150 g/d in some embodiments; a high tenacity, for example greater than about 5 g/d in some embodiments, and greater than about 7 g/d in other embodiments; yarns can also be fairly resistant to stretching, for example, the yarn can exhibit an elongation of less than about 10% as measured by ASTM D2256; at least one of the filaments in the yarn can possess greater than 80% crystallinity, according to known wide-angle x-ray scattering (WAXS) measuring techniques; at least one of the filaments in the yarn can have a ratio of equatorial intensity to meridonal intensity greater than about 1.0 (3.0 in one embodiment), which can be obtained from known small angle x-ray scattering (SAXS) measuring techniques; a drawn size of between about 0.5 denier per filament and about 100 denier per filament; an elongation percentage of less than about 15%, as measured in ASTM D2256-02 (in another embodiment, the yarn can exhibit less than about 10% elongation, for example, less than about 8% elongation); at least one filament of the first yarn component has a size of less than 300 denier (300 g/9000 m). In one embodiment, at least one filament of the first yarn component is between 0.5 and 100 denier (one embodiment between 0.5 and 50 denier); diameter of at least one filament is less than 100 μm. In one embodiment at least one filament is less than 75 μm; at least one filament is less than 60 μm; at least one filament is less than 50 μm;

The tensile strength of at least one filament of the first yarn component can have a tensile strength of greater than 7 grams/denier; 8 grams/denier; or 9 grams/denier as measured by ASTM D2256. Its modulus can be greater than 100 grams/denier, greater than 150 grams/denier, greater than 180 grams/denier or greater than 200 grams/denier. The elongation can be between 5% and 15%, 5% and 12% or 5% and 10%.

The first yarn component can include a nucleating agent. The first yarn component can be a polyolefin formed predominantly from any alpha-olefin monomer. The polyolefin can be polyethylene, polypropylene, polybutylene, or poly-4-methylpentene. The polyolefin can be a homopolymer. The polyolefin can be a blend of at least one polyolefin with one other polymer. The other polymer can be a thermoplastic, thermoset, different polymer from the polymer or non-olefinic polymer. The first yarn component blend can be miscible or immiscible. The polyolefin can be a copolymer of at least one olefin monomer with at least one other monomer.

Other additives can be included with the hybrid yarn.

In one embodiment, the first yarn component is a plurality of filaments. In one embodiment, there are greater than three filaments. The filaments can be substantially continuous. The average filament length can be greater than 100 cm. The average filament length can be between 10 cm and 100 cm.

In one embodiment, at least one of the filaments comprising the first yarn component has a specific gravity of less than 0.96 g/cm3, as calculated by the formula below, where m=the mass of the sample in grams, I is the length of the sample, and the average radius (r) of the yarn is determined by microscopic measurement

$$Specific Gravity = \frac{m}{π {r}^{2} 1}$$

The specific gravity can also be less than 0.93 g/cc or less than 0.91 g/cc.

One of the filaments comprising the first yarn component can have a surface area of greater than 0.8 m2/g, greater than 1.0 m2/g or greater than 1.5 m2/g.

In one embodiment, at least one of the filaments comprising the first yarn component, the ratio of the predicted surface area to the measured surface area is greater than 1.1. The predicted surface area can also be greater than 1.25 or greater than 1.5. The predicted surface area is calculated by SA=πdl where d=the average diameter of the filament as determined by microscopic measurement, and I is the length of 1 gram of filament sample. Actual surface area is measured by nitrogen BET technique

In one embodiment, at least one of the filaments comprising the first yarn component is internally comprised of a plurality of microfibrils, wherein said filament further exhibits a plurality of voids interspersed within said microfibrils, wherein both said microfibrils and voids are aligned substantially parallel to the longitudinal axis of said fiber.

The second yarn component can be is comprised of one or more sub-yarn components which differ from the first yarn component. The second yarn component can include a plurality of filaments and in one embodiment, 3 or more filaments. The second yarn component can be substantially continuous filaments with the average filament length is greater than 100 cm. The second yarn component can be of discontinuous filaments where the average length can be between 10 to 100 cm. At least one filament of the second yarn component can be less than 300 denier per filament (300 g/9000 m). The denier of at least one filament of the second yarn component can be 0.5 to 100, 0.5 to 50 or 0.5 to 10. The diameter of the filaments comprising the second yarn component can be less than 100 micrometers, less than 50 micrometers, less than 25 micrometers or less than 15 micrometers.

At least one of the sub-yarn components of the second yarn component can be comprised of “high performance” fibers that exhibit one or more of the following: tenacity>7 grams/denier, elastic modulus>40 grams/denier and elongation at break<10%, tenacity>15 g/den, elastic modulus>200 g/den, and elongation at break<8%, tenacity>20 g/den, elastic modulus>300 g/den, elongation at break<6%.

At least one of the sub-yarn components of the second yarn can be comprised of glass, carbon, poly(phenylene terephthalamide), poly(vinyl alcohol), poly(1,4-phenylene-2,14-benzobisoxazole) (PBO), poly(1,4-phenylene-2,14-benzobisthiazole) (PBT), poly(ethylene-2,14-naphthalate) (PEN), lyotropic liquid crystalline polymers such as Vectran™ formed by polycondensation of aromatic organic monomers to form aromatic polyesters, polyamides, and the like, alumina-silicates such as basalt, regenerated cellulosic materials, ultra-high molecular weight polyethylene (UHMWPE) and the like. The second yarn component can also be one from the list of fiber types detailed in U.S. Pat. No. 5,376,426 incorporated by reference or United State Patent Application Publication 2006/0053442 incorporated by reference.

The first yarn component and the second yarn component can be brought together in a process in a substantially parallel orientation and are subjected to a process to intermingle the filaments of the first and second yarn components so as to create a substantially homogeneous yarn structure. The process can be a controlled aerodynamic combinatorial process.

One aspect of the present invention is the formation of fiber-reinforced polymeric composite structures made in part from the described composite “hybrid” yarns having a first yarn component and the second yarn component and can include a polymeric resin component. The composite yarn component can serve as a fiber reinforcement component. The polymeric resin component can be a thermosetting polymer including epoxy resins, polyurethane resins, unsaturated polyester resins, vinyl ester resins, phenolic resins, and the like, and any combination thereof. The polymeric resin component can be a thermoplastic polymer including polyolefins, polyurethanes, polyamides, polyesters, and the like and any combination thereof.

The fiber reinforcement component can be a combination of the first yarn component or the second yarn component combined with non-hybrid yarns comprised of a material different from the first yarn component in the hybrid yarn. The non-hybrid yarns can include “high performance” yarns made from glass, carbon, basalt, polyaramid, UHMWPE, and the like or any combination thereof. The first yarn component of the hybrid yarn does not substantially melt in the composite formation process. The first yarn component of the hybrid yarn does not substantially dissolve in the polymeric resin component.

The fiber reinforcement component can be of a two-dimensional structure, such as a fabric and include woven fabrics, weft-insertion warp-knit fabrics, stitch-bonded nonwoven fabrics, two-dimensional braided fabrics, woven “unidirectional” fabrics, nonwoven “unidirectional” fabrics, where said two-dimensional structures may contain the hybrid yarns in the 0° direction (warp), 90° direction (weft), or at off-axis angles between 0° and +/−90°. The first yarn component and the second yarn component can form a two-dimensional structure themselves. The hybrid yarns can be used to form a two-dimensional structure in combination with non-hybrid yarns comprised of a material different from the first yarn component in the hybrid yarn.

The fiber reinforcement component can be a three-dimensional structure, such as a braid where the hybrid yarns are used to form a three-dimensional structure by themselves. The hybrid yarns can be combined with non-hybrid yarns comprised of a material different from the first yarn component to form a three-dimensional structure, such as a braid or ropes or a braided rope. The fiber reinforcement component can be wrapped around a form as part of the composite structure formation process. The fiber reinforcement component can be comprised of multiple layers of two-dimensional structures, such as sheets of fabrics, or of multilayered three-dimensional structures, such as braids. At least one layer of the fiber reinforcement component can be comprised at least in part of a hybrid yarn as described herein.

Fiber reinforced polymer composite structures, where the fiber reinforcement component is comprised at least in part of the “hybrid” composite yarn of the present invention can exhibit superior resistance to damage than structures made from conventional high-performance reinforcing fibers such as glass or carbon. In one embodiment, fiber reinforced polymer composite structures comprised at least in part of the “hybrid” composite yarn of the present invention may be used in solid laminate structures, in hollow laminate structures such as tubes, or in laminate structures that include a low density core material.

In one embodiment, fiber reinforced composites structures comprising the “hybrid” composite yarn of the current invention may be used as tubular structures such as shafts for recreational equipment like fishing rods, hockey and lacrosse sticks, oars, paddles, racquets, tent poles, golf clubs, ski poles, bicycle frames, baseball and cricket bats, masts for sailboats, antennae, shafts, musical instruments, vaulting poles, javelins, arrows, bows, percussion mallets; for industrial equipment such as lightweight trusses, power poles, tool handles, and framing materials; for medical applications such as prosthetics, canes, crutches, wheelchairs, and components of medical tables, gurneys, and litters. Other such tubular applications can include canes, crutches, field hockey sticks, framing materials, golf shafts and grips, gurneys, lawn equipment, lightweight trusses, litters, power poles, prosthetics, wheelchairs, windblades and propellers.

In one embodiment, fiber reinforced composite structures comprising the “hybrid” composite yarn of the current invention may be used as panel structures for application in protective equipment, such as body armor for recreational or law-enforcement applications, luggage, cases, rifle stocks and helmets. In another embodiment, fiber reinforced composite structures comprising the “hybrid” composite yarn of the current invention may be used as panel structures for application in transportation applications such as body panels for automobiles, trucks, shipping containers, boat hulls, aerodynamic shrouds for aircraft, trucks, trains, or marine craft, and the like. In another embodiment, fiber reinforced composite structures comprising the “hybrid” composite yarn of the current invention may be used as panel structures for application in recreational equipment such as skis, shoes, blades for paddles/oars, backpack frames, portable docks, surfboards, sleds, cases, motorized personal watercraft or snowmobiles, and the like.

In the panel or laminate configuration, applications can include archery equipment & bows, ballistic plates (blast protection), battery housings, fins, gun stocks, hurricane proof structures, impact panels, interior (train, automotive, aircrafts, trucks), lawn mowing equipment, litters, carriers, backboards, nosecones, oil & gas production components/billets, personal protection equipment, racquets, golf clubs, satellite dishes, showers & tubs, siding, speakers, storage systems, structural support & repair (bridges, retaining walls), portable docks, kayaks, skis—snow and water, aerodynamic shrouds for aircraft, trucks, trains, marine craft, snowmobiles, shoes, skates, boots, cleats, protective helmets—recreational, industrial, military, blades for paddles/oars, protective equipment and padding, cases, marine applications—boat decks & air vent panels, goalie masks, armor for recreation, law enforcement, military (shields & panels), luggage, canoes, backpack frames, hockey sticks, kayaks, automobiles, sleds, motorized personal watercraft, shipping containers & cargo containers, boat interiors, boat hulls, snowboards, radomes, amphibious aircraft, surfboards, sup, windsurf, kiteboard, wakeboard, skimboards, surveillance aircraft, tank liners, tires, transportation applications-body panels, housing, trucks—panels, skirting, bumpers, wheels, windblades, window and door frames, x ray tables, bike wheels, snowshoes, safety garments and fencing gear.

### EXAMPLES

“Hybrid” Composite yarn samples were formed by combination of a first yarn component and a second yarn component in a substantially parallel orientation using a controlled aerodynamic turbulence applied in a chamber to intermingle the first and second yarn components, using equipment such as the DS60 machinery made by Dietze & Schell for air-texturing of glass fibers.

A high-modulus polypropylene yarn, as described in Tables 1-3 above, was used as the First Yarn Component. First Yarn Components used were Innegra™ S yarns in 625 denier and 940 denier yarn sizes. Second Yarn Components used were E-glass, carbon, and basalt yarns. The E-glass yarn used was a resin-compatible yarn (RCY), size G75, with 0.7Z twist from AGY. In one embodiment, the E-glass is alumino-borosilicate glass with less than 1% w/w alkali oxides. The carbon yarn used was an AS4-GP-3k type from Hexcel. The carbon yarn can have one or more of the following physical properties: tensile strength of about 670 ksi, elongation failure of failure of about 1.8%, density of about 0.00647 lb/in², weight/length of about 11.8×10⁻⁶ lb/in, diameter of about 1.82 c 10⁻⁴ in², filament diameter of about 0.280 mil, carbon content at least 90% and can be about 94.0%. The basalt yarn used was a 110 tex size from Kamenny Vek.

Table 4 tabulates the formation conditions of nine different samples of composite yarns.

TABLE 4

| | | | | | | Number | | | Weight |
|---|---|---|---|---|---|---|---|---|---|
| Exemplary | | First | Number | | Second | of | Composite | Weight | % |
| Composite | | Yarn | of First | Second | Yarn | Second | Yarn | % First | Second |
| Yarn No. | First Yarn | Denier | Yarns | Yarn | Denier | Yarns | Denier | Yarn | Yarn |
| 1 | High-modulus | 940 | 1 | E- | 620 | 1 | 1629 | 60 | 40 |
| | polypropylene | | | glass, | | | | | |
| | | | | G75 | | | | | |
| | | | | 0.7Z | | | | | |
| | | | | RCY | | | | | |
| 2 | High-modulus | 940 | 2 | E- | 620 | 1 | 2556 | 75 | 25 |
| | polypropylene | | | glass, | | | | | |
| | | | | G75 | | | | | |
| | | | | 0.7Z | | | | | |
| | | | | RCY | | | | | |
| 3 | High-modulus | 940 | 1 | E- | 620 | 2 | 2266 | 40 | 60 |
| | polypropylene | | | glass, | | | | | |
| | | | | G75 | | | | | |
| | | | | 0.7Z | | | | | |
| | | | | RCY | | | | | |
| 4 | High-modulus | 625 | 1 | E- | 620 | 3 | 2813 | 25 | 75 |
| | polypropylene | | | glass, | | | | | |
| | | | | G75 | | | | | |
| | | | | 0.7Z | | | | | |
| | | | | RCY | | | | | |
| 5 | High-modulus | 940 | 1 | carbon, | 1800 | 1 | 2791 | 35 | 65 |
| | polypropylene | | | AS4- | | | | | |
| | | | | GP-3k | | | | | |
| 6 | High-modulus | 940 | 2 | carbon, | 1800 | 1 | 3831 | 53 | 47 |
| | polypropylene | | | AS4- | | | | | |
| | | | | GP-3k | | | | | |
| 7 | High-modulus | 625 | 1 | carbon, | 1800 | 1 | 2520 | 30 | 70 |
| | polypropylene | | | AS4- | | | | | |
| | | | | GP-3k | | | | | |
| 8 | High-modulus | 625 | 2 | carbon, | 1800 | 1 | 3084 | 40 | 60 |
| | polypropylene | | | AS4- | | | | | |
| | | | | GP-3k | | | | | |
| 9 | High-modulus | 625 | 1 | basalt | 990 | 2 | 2654 | 24 | 76 |
| | polypropylene | | | | | | | | |

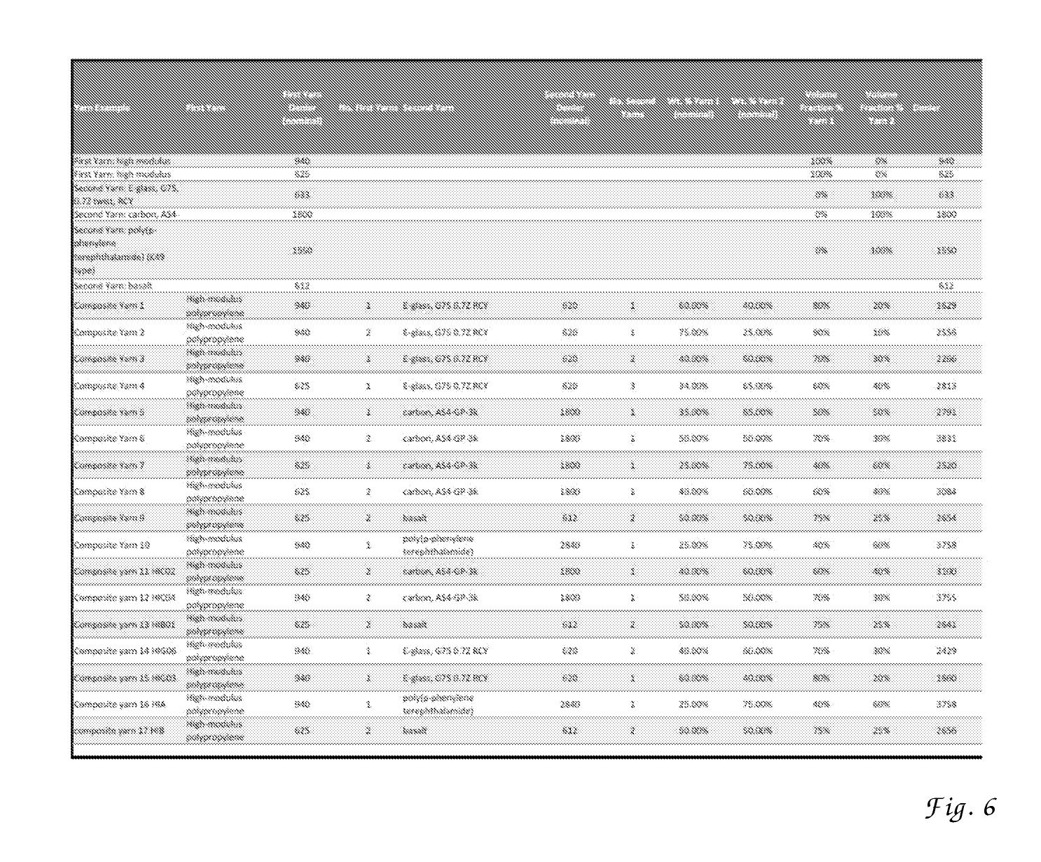

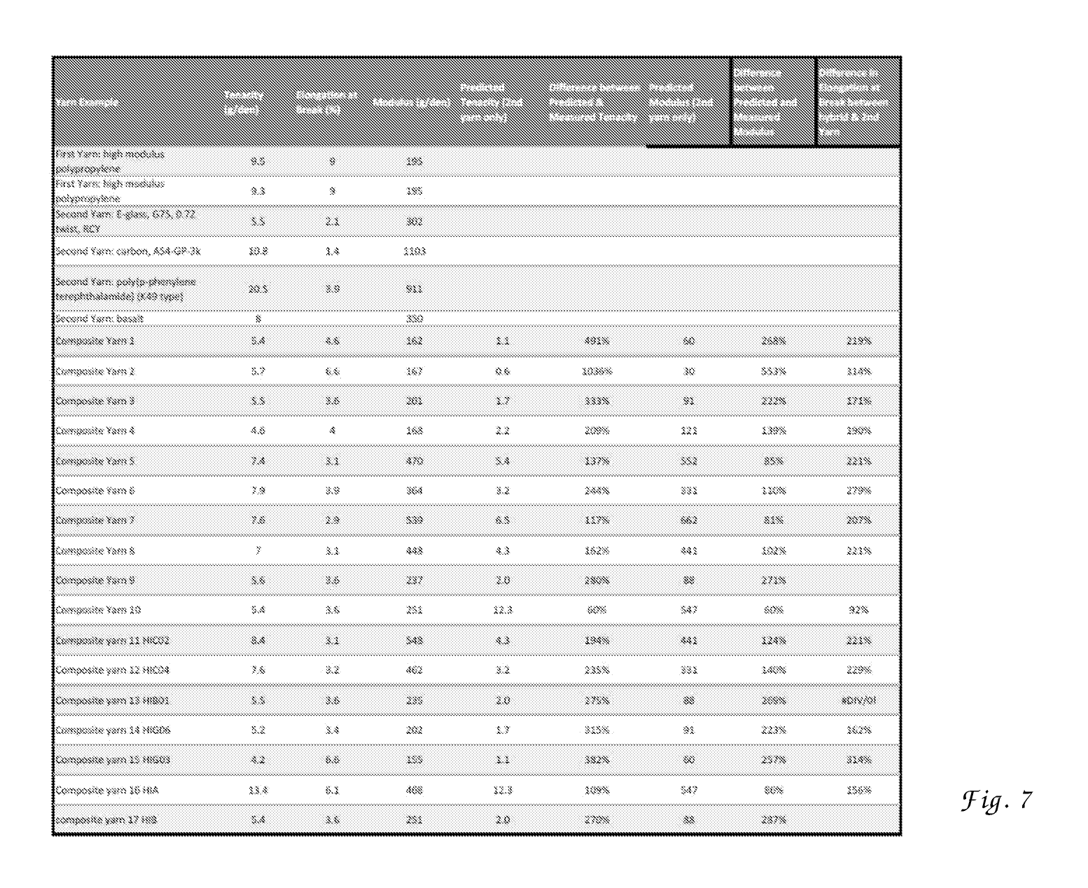

FIGS. 6 and 7 illustrate additional conditions of the above samples and additional samples of composite yarns.

Following formation, the samples were subjected to tensile testing according to ASTM D2256, previously incorporated by reference, to obtain the yarn tensile strength, tenacity, modulus, and elongation at break. Testing results of the first and second yarn components alone are shown for comparison. Results are shown in Table 5. In one embodiment, the modulus can be within 15% of the modulus shown below.

TABLE 5

| | | | Elongation | |
|---|---|---|---|---|
| | | Tenacity | at Break | Modulus |
| Yarn Example | Denier | (g/den) | (%) | (g/den) |
| First Yarn: high modulus | 940 | 9.5 | 9 | 195 |
| polypropylene | | | | |
| First Yarn: high modulus | 625 | 9.3 | 9 | 195 |
| polypropylene | | | | |
| Second Yarn: E-glass, G75, | 633 | 5.5 | 2.1 | 302 |
| 0.7Z twist, RCY | | | | |
| Second Yarn: carbon, | 1800 | 10.8 | 1.4 | 1103 |
| AS4-GP-3k | | | | |
| Composite Yarn 1 | 1629 | 5.4 | 4.6 | 162 |
| Composite Yarn 2 | 2556 | 5.7 | 6.6 | 167 |
| Composite Yarn 3 | 2266 | 5.5 | 3.6 | 201 |
| Composite Yarn 4 | 2813 | 4.6 | 4.0 | 168 |
| Composite Yarn 5 | 2791 | 7.4 | 3.1 | 470 |
| Composite Yarn 6 | 3831 | 7.9 | 3.9 | 364 |
| Composite Yarn 7 | 2520 | 7.6 | 2.9 | 539 |
| Composite Yarn 8 | 3084 | 7.0 | 3.1 | 448 |
| Composite Yarn 9 | 2654 | 5.6 | 3.6 | 237 |

When investigated visually, the composite yarn examples were found to have the first and second yarns intermingled sufficiently well that the first and second yarns could not be separated back into the individual component yarns.

In composite yarns, the stiffest (highest modulus) yarn component will load preferentially in tensile testing and will thus dominate the measurement of the composite yarn tensile strength and modulus properties. As the difference increases between the tensile properties of the different yarn components in a composite yarn, the more the stiffest yarn component will influence the measurement of the composite yarn tensile strength and modulus properties. Additionally, the more independently the first and second yarn component act from one another, the more the stiffest yarn component will dominate the measurement of the composite tensile strength and modulus properties. Therefore, at a first approximation, the tensile strength and modulus of a composite yarn can be estimated by the product of the volume fraction of the stiffest yarn component and the tensile strength (or modulus) of the stiffest yarn component.

In the composite yarns of the present invention, the first and second yarns are blended in a homogeneous fashion, such that the two component yarns do not load independently, but rather begin to load in parallel. This results in a measured tensile strength generally greater than that of the stiffest yarn component alone, and also in a tensile modulus generally greater than that of the stiffest yarn component alone. By virtue of the homogeneous blending of the first and second yarns in the composite yarn structure, the elongation at break of the composite yarn is also greater than that of the stiffest yarn component alone.

The invention can include composite laminates that can exhibit high strength and/or low dielectric loss and can also be lightweight. The laminates include layers formed of high modulus polyolefin fiber. The fibers can be woven, knit or blended to form a fabric or can be included in a nonwoven fabric that can be one or more layers of the composite structures. The layers including the high modulus polyolefin fibers can include other fibers, such as fiberglass (including eglass), carbon fiber or others. The composites can also include layers of other materials, for instance layers formed of polyaramids, fiberglass, or carbon fiber wovens or nonwovens. The composites can advantageously be utilized in low loss dielectric applications, such as in forming circuit board substrates, or in applications beneficially combining strength with low weight, such as automobile and boat materials.

In one embodiment, the invention can be directed to multi-layer composite structures, methods for forming the structures, and methods for using the structures. In one embodiment, the disclosed structures can include a first layer including a semi-crystalline polyolefin fiber having a modulus greater than about 8 GPa, and even higher in other embodiments, and a maximum cross-sectional dimension less than about 100 μm. The polyolefin fibers can also exhibit a high tenacity, for example greater than about 400 MPa and can have a low density, for instance less than about 1.3 g/cm3, in one embodiment. The composite structures also include a second layer that can be the same as or different from the first layer and a polymeric binding agent that can secure the layers one to another. In one embodiment, the polyolefin can be a polypropylene. In one particular embodiment, the polyolefin fiber can be formed via a melt extrusion process, for instance in a melt extrusion process involving a draw with a draw ratio of at least about 6.

In one embodiment, the first layer including the polyolefin fiber can be a weave fabric or a nonwoven. Optionally, the fabric can include composite yarns that include the polyolefin fiber in combination with a second fiber, e.g., glass, carbon, polyaramids, or the like. In one embodiment, the fabric can include high modulus polyolefin yarns as well as fibers of other materials, e.g., glass fibers, etc.

The second layer of the composite structures can be identical to or different from the first layer, as desired. For instance, the second layer can also include the high modulus polyolefin fibers in the same or a different arrangement as the first layer, or can be formed from completely different materials. For example, the second layer can be a fiberglass woven or nonwoven, a woven or nonwoven including another type of fiber that can be held in a polymeric matrix, or a metal construct.

The binding agent of the composite can be a thermoplastic or a thermoset. For example, the binding agent can be a thermoplastic film or resin placed between the layers or coated onto the fibers or formed layers, and the composite can be shaped and cured in a compression molding process that can include placing the construct under heat and/or pressure.

Optionally, the binding agent can be a thermoset resin. For instance the thermoset resin can be an epoxy thermoset resin. A thermoset resin can be included in the composite according to any process. For instance, the thermoset resin can be applied to the high modulus polyolefin fibers, to the polyolefin-containing layer(s), and/or to the materials forming a second, different layer of the composite. For instance, the thermoset resin that can bind the layers together can also form a polymeric matrix about the fibers of another layer, e.g., a fiberglass layer.

The invention is not limited to high modulus multi-filament fibers formed according to the above-described process. For example, in another embodiment, one or more layers of the disclosed composite structures can incorporate high modulus. polyolefin fibers formed from an extruded film. For example, a high modulus melt processed film such as that described in U.S. Pat. No. 6,110,588 to Perez, et al., which is incorporated herein by reference, can be utilized in forming fibers and fibrous webs for the disclosed composite structures.

In one embodiment, a highly oriented, semi-crystalline, melt processed film can first be formed with an induced crystallinity. An induced crystallinity higher than that normally attainable in a melt processed film can be obtained by a combination of casting and subsequent processing such as calendaring, annealing, stretching, and/or recrystallization. Following formation of the film, the film can be further processed to form the fibers and fabrics for use in the composite structures of the invention.

The highly oriented, highly crystalline film can be further processed to form high modulus fibers for use in the disclosed composite structures. For example, in one embodiment, the film can be sliced or cut according to methods as are generally known in the art so as to form a plurality of high modulus tape fibers.

In another embodiment, the film can be fibrillated and/or micro-fibrillated to release macro-fibers and/or micro-fibers from the film. For instance, in one embodiment, the film may be subjected to a fibrillation step using conventional mechanical means to release macroscopic fibers from the highly oriented film. One exemplary means of mechanical fibrillation uses a rotating drum or roller having cutting elements such as needles or teeth that can contact the film as it moves past the drum. The teeth may fully or partially penetrate the surface of the film to impart a fibrillated surface thereto. Other similar macro-fibrillating treatments are known and include such mechanical actions as twisting, brushing (as with a porcupine roller), rubbing, for example with leather pads, and flexing. The fibers obtained by such conventional fibrillation processes can be macroscopic in size, are generally several hundreds of microns in cross section, and may be either semi-detached or completely detached from the film.

Micro-fibrils formed according to such a process are generally several orders of magnitude smaller in diameter than the fibers obtained by mechanical means and can range in size from less than about 0.01 microns to about 20 microns.

In one particular embodiment, organic materials to be included in the composite structure, and in particular the high modulus polypropylene fibers or layer formed thereof can be oxidized prior to combining individual layers one to another, so as to promote better bonding of the layers. For example, high modulus polypropylene fibers can be oxidized either before or after a fabric forming process according to any suitable oxidation method including, but not limited to, corona discharge, chemical oxidation, flame treatment, oxygen plasma treatment, or UV radiation. In one particular example, atmospheric pressure plasma such as that created with an Enercon Plasma3 unit using an 80% helium and 20% oxygen atmosphere at a moderate power level can be formed and a fabric or fiber can be treated with the plasma so as to create reactive groups that can improve wetting and binding of the fibers to thermoset resins such as epoxy or unsaturated polyester resin systems.

In one embodiment, a composite structure of the invention can be used in forming a protective structure that can be essentially impervious to weather, dirt, and/or other elements that could damage devices that can be placed within the protective structure. In one particular embodiment, such a protective structure, and in particular, that portion of the protective structure formed of a composite of the present invention can be transparent to electromagnetic waves of various frequencies. As such, an electromagnetic wave could be provided, such as that transmitted from or received by a communications antenna, microwave tower, a radar transmitter/receiver, or any other transmission device. The protective structure could thus protect the electrical devices held within the protective structure, but would not impede the operation of the devices, as the electromagnetic waves passing to and/or from the electrical devices held within the protective structure can pass through the laminate composites of the protective structure. Such a protective laminate material can include various composite structures as herein described. For instance, in one embodiment an electromagnetically transparent laminate material can include one or both external layers composed of glass, Kevlar, or ultra-high-molecular-weight-polyethylene, in addition to one or more inner layers comprising the high modulus polypropylene fibers.

In one embodiment, the invention is a composite multi-layer structure that includes a plurality of high modulus, high tenacity polypropylene fibers in at least one layer. The disclosed composites also include a second layer that can be the same as or different from the first layer, and a polymeric binding agent. It has been discovered that due to the unique and beneficial characteristics of high strength polyolefin fibers, and in particular, those exhibiting high modulus and high tenacity in combination with low density and low dielectric constant, these materials can be beneficially combined with a suitable polymeric binding agent according to any suitable combinatorial process and optionally in conjunction with layers formed of other materials to form the composite materials of the present invention.

The composite structures can include specifically pre-designed materials to form a composite for use in a particular application. For example, due to the low dielectric constants of the polyolefins used in the composites, the composite structures can be beneficially used in many low loss electrical applications. In one particular embodiment, one or more layers of the composite can comprise a plurality of high modulus polypropylene fibers, and the composite structure can be essentially transparent to electromagnetic radiation. According to this particular embodiment, a construct of the invention may be beneficially utilized as a circuit board or as a protective enclosure for an electromagnetic sending and/or receiving device, such as a radome. Electrical devices of the present invention can exhibit improved characteristics as compared to previously known devices that do not include high modulus polyolefin fibers. For example, the dielectric constant and/or dielectric loss can be less than that of previously known laminates utilized in similar applications. For example, composites of the present invention can exhibit a dielectric constant of less than about 3.5 in one embodiment. In another embodiment, the dielectric constant can be lower, for example, less than about 3.0, or even lower in other embodiments, for example less than about 2.7.

In one particular embodiment, one or both exterior surfaces of a device of the invention particularly well-suited to electrical applications can include a reinforcement fiber having high thermal stability, such as glass, for example. This can enable the device to be used in high temperature processes such as those involving standard solder processes, among others.

Glass fiber/epoxy composites have high dielectric constant and high loss, however. Composites such as those described herein including a plurality of melt extruded fibers with high modulus can have a lower dielectric constant than these previously known substrates. For example lower than about 3.0, or about 2.5, or even lower than about 2.2 in some embodiments.

The semi-crystalline polyolefins used in forming one or more individual layers of one embodiment of the disclosed composites can have a low dielectric constant as well as a low dielectric loss. For example, the dielectric constant of the composite could be below about 4.0, or below about 3.5, or even below about 3.0 in some embodiments. As such, in one embodiment, the disclosed composite materials can be essentially transparent to electromagnetic waves and can be beneficially utilized in electrical applications, for example in forming reasonably priced circuit board substrates suitable for high frequency electrical applications or for use as radomes or other protective enclosures or coverings of electrical circuitry.

In one embodiment of the present invention, sample fabrics were woven from several of the example hybrid composite yarns using a rapier loom. All fabrics were a plain-weave configuration. These sample fabrics were then used to construct layered composite laminates, where each composite laminate panel was comprised of two or three plies of the a sample fabric and one ply of style number 1522 fiberglass fabric, using a vacuum infusion process using SP115 epoxy resin and hardener from Gurit. The panels were infused and cured for 24 hours at 75° F., followed by a 16 hour post-cure heat exposure at 120° F. Comparison panels were made from plain weave HTS-40-3k carbon fiber. Construction details for the sample fabrics and test panels are summarized in Table 6.

TABLE 6

| | | | | | Panel Specifications | | | | |
|---|---|---|---|---|---|---|---|---|---|
| | | | | | With Surface Ply 1522 FG | | | | |
| Fabric Specifications | | | | | (0.005 thick) | | | | |
| | | Fabric | | | | | | Avg. Wt. | |
| Panel | Example | Weight | | Fabric | | | Avg | % Fiber | |
| Example | Yarn | (gsm) | | Thickness | # | | Thick | in Panel | Density |
| Number | No. | (osy) | | (in) | Plies | Layup | (in) | (%) | (oz/in³) |
| Example 10 | 7 | 256.6 | 7.7 | 0.023 | 2 | 0/90 | 0.057 | 36% | 0.622 |
| Example 11 | 7 | | | | 3 | 0/45/90 | 0.080 | 35% | 0.666 |
| Example 12 | 8 | 289.5 | 8.7 | 0.025 | 3 | 0/45/90 | 0.089 | 37% | 0.627 |
| Example 13 | 5 | 279.2 | 8.4 | 0.024 | 2 | 0/90 | 0.060 | 37% | 0.611 |
| Example 14 | 5 | | | | 3 | 0/45/90 | 0.085 | 37% | 0.643 |
| Example 15 | 6 | 324.3 | 9.7 | 0.027 | 3 | 0/45/90 | 0.092 | 39% | 0.651 |
| Example 16 | 3 | 277.0 | 8.3 | 0.018 | 3 | 0/45/90 | 0.060 | 47% | 0.706 |
| Comparison 1 | HTS40 | 196.0 | 5.9 | 0.008 | 3 | 0/45/90 | 0.033 | 54% | 0.803 |
| Comparison 2 | 3K | | | | 4 | [0/45]²s | 0.041 | 59% | 0.782 |
| Comparison 3 | Carbon | | | | 5 | 0/45/90/45/0 | 0.049 | 60% | 0.804 |
| Comparison 4 | | | | | 6 | [0/45/90]²s | 0.057 | 62% | 0.796 |

The thus produced fiber-reinforced polymer composite panels were then tested for impact resistance by the drop-impact method described in ASTM D5420 configuration GA. The striking force required to produce a failure in the panel was recorded. For comparative purposes, the ratio of striking force at failure to panel thickness and the ratio of striking force at failure to panel density were calculated. Results of this impact testing are reported in Table 7.

TABLE 7

| | | Impact Testing Results | | |
|---|---|---|---|---|
| Fabric Specifications | | Impact | Force vs. | Force vs. |
| Panel Example | Example | Failure | Thickness | Wt |
| Number | Yarn No. | (lbs) | (lbf/in) | (lbf/oz) |
| Example 10 | 7 | 30 | 526 | 28 |
| Example 11 | 7 | 60 | 750 | 37 |
| Example 12 | 8 | 80 | 899 | 47 |
| Example 13 | 5 | 40 | 667 | 36 |
| Example 14 | 5 | 80 | 941 | 48 |
| Example 15 | 6 | 90 | 978 | 50 |
| Example 16 | 3 | 80 | 1333 | 62 |
| Comparison 1 | HTS40 | 30 | 909 | 37 |
| Comparison 2 | 3K | 40 | 976 | 41 |
| Comparison 3 | Carbon | 50 | 1020 | 42 |
| Comparison 4 | | 70 | 1228 | 51 |

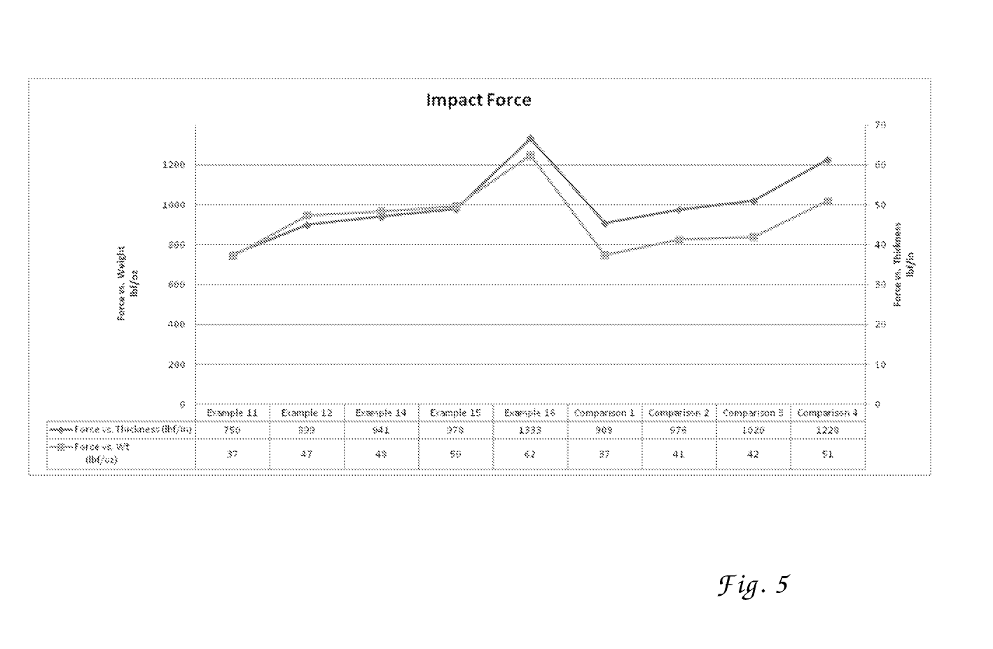

Comparisons were made between the 3-ply example panel impact test ratio results and are shown graphically in FIG. 5.

As can be seen in the comparative ratios, the 3-ply composite panels made from the example fabrics comprised of the hybrid composite yarns of the present invention exhibit equivalent or superior impact force vs. weight to a comparative 3-ply construction from 100% carbon fiber fabric. When compared on impact force vs. thickness, the 3-ply composite panel examples 12, 14, 15, 16 made from the example fabrics comprised of the hybrid composite yarns of the present invention exhibit equivalent or superior impact force to comparative example 3, comprised of 3 plies of 100% carbon fabric, and are approximately equivalent to comparative examples 2 and 3 comprised of 4 and 5 plies of 100% carbon fabric, respectively. Thus, the inventive hybrid composite yarns of the present application can provide superior impact force resistance when used as the fiber reinforcement component in fiber reinforced polymer constructions. By varying the ratio of the first yarn component to the second yarn component in the hybrid composite yarn, both the tensile strength properties and the impact resistance properties of fiber-reinforced composite structures made using said hybrid composite yarns can be manipulated.

It will be appreciated that the foregoing examples, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention that is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. A hybrid composite structure comprising:
a laminate including two plies of fabric wherein the fabric includes a composite yarn;
a first polyolefin yarn included in the composite yarn having about 80% crystallinity according to WAXS measuring techniques;
a second yarn physically combined with the first polyolefin yarn and included in the composite yarn; and,
wherein the laminate has the physical property of impact energy absorption more than 50% higher than a panel made with an equivalent weight of the second yarn alone as measured by the ASTM D5420 drop-impact testing method.

2. The structure of claim 1 wherein the second yarn is taken from the group consisting of glass; quartz; carbon; poly(p-phenylene terephthalamide), poly(m-phenylene terephthalamide); poly(vinyl alcohol); poly(1,4-phenylene-2,14-benzibisoxazole) (PBO); poly(1,4-phenylene-2,14-benzobisthiazole) (PBT); poly(benzimidizole) (PBI); poly(ethylene-2,14-naphthalate) (PEN); lyotropic liquid crystalline polymers formed by polycondensation of aromatic organic monomers to form aromatic polyesters, polyamides, aluminia-silicates, basalt, regenerated cellulosic materials and ultra-high molecular weight polyethylene (UHMWPE).

3. The structure of claim 2 wherein the composite yarn has at least one of the following properties: tenacity greater than about 100% of the expected tenacity based on the volume fraction of the second; an initial modulus greater than about 100% of the expected modulus based on the volume fraction of the second; elongation at break less than about 320% of the elongation at break of the second

4. The structure of claim 1 wherein at least one ply is a woven fabric.

5. The structure of claim 1 wherein one ply is of a different material from that of the other ply.

6. The structure of claim 4 including a binding agent placed between the plies.

7. The structure of claim 1 wherein first polyolefin yarn is included in the composite yarn of at least one ply in the range of 26% to 51% by weight.

8. The structure of claim 1 including:
filaments included in the first polyolefin yarn; and,
a plurality of microfibrils included in at least one of the filaments wherein the filament includes a plurality of voids interspersed within the microfibrils, wherein both said microfibrils and voids are aligned substantially parallel to the longitudinal axis of the first polyolefin yarn.

9. The structure of claim 1 wherein the first polyolefin yarn is a blend of a first polyolefin and a second polymer taken from the group consisting of: thermoplastic, thermoset, and non-olefinic polymer.

10. A hybrid composite structure comprising:
a laminate including two plies of fabric wherein the fabric includes a composite yarn;
a first polyolefin yarn included in the composite yarn having at least one filament where the filament has a ratio of equatorial intensity to meridonal intensity greater than about 1.0 according to SAXS measuring techniques;
a second yarn physically combined with the first polyolefin yarn and included in the composite yarn; and,
wherein the laminate has the physical property of impact energy absorption more than 50% higher than a panel made with an equivalent weight of the second yarn alone as measured by the ASTM D5420 drop-impact testing method.

11. The structure of claim 10 where the composite yarn has at least one of the following physical properties: tenacity greater than about 100% of the expected tenacity based on the volume fraction of the second yarn; an initial modulus greater than about 100% of the expected modulus based on the volume fraction of the second yarn; elongation at break less than about 320% of the elongation at break of the second yarn.

12. The structure of claim 10 where the first polyolefin yarn has a denier of less than about 300 grams/9000 meters.

13. The structure of claim 10 wherein the first polyolefin yarn has a modulus greater than about 40 grams/denier.

14. The structure of claim 10 wherein the second yarn is taken from the group consisting of: glass; quartz; carbon; poly(p-phenylene terephthalamide), poly(m-phenylene terephthalamide); poly(vinyl alcohol); poly(1,4-phenylene-2,14-benzibisoxazole) (PBO); poly(1,4-phenylene-2,14-benzobisthiazole) (PBT); poly(benzimidizole) (PBI); poly(ethylene-2,14-naphthalate) (PEN); lyotropic liquid crystalline polymers formed by polycondensation of aromatic organic monomers to form aromatic polyesters, polyamides, aluminia-silicates, basalt, regenerated cellulosic materials and ultra-high molecular weight polyethylene (UHMWPE).

16. The structure of claim 10 wherein the first polyolefin yarn is a blend of a first polyolefin and a second polymer taken from the group consisting of: thermoplastic, thermoset, and non-olefinic polymer.

17. The structure of claim 10 wherein the first polyolefin yarn is polypropylene.

18. The structure of claim 10 wherein the laminate is in an arrangement taken from the group of solid laminates, hollow laminates, tubular laminates, panel structure,

19. A hybrid composite structure comprising:
a laminate including two plies of fabric wherein the fabric includes a composite yarn;
a first polyolefin yarn included in the composite yarn having at least one physical property taken from the group of about 80% crystallinity according to WAXS measuring techniques and having filaments wherein at least one of the filaments has a ratio of equatorial intensity to meridonal intensity greater than about 1.0 according to SAXS measuring techniques;
a second yarn included in the composite taken from the group consisting of: glass; quartz; carbon; poly(p-phenylene terephthalamide), poly(m-phenylene terephthalamide); poly(vinyl alcohol); poly(1,4-phenylene-2,14-benzibisoxazole) (PBO); poly(1,4-phenylene-2,14-benzobisthiazole) (PBT); poly(benzimidizole) (PBI); poly(ethylene-2,14-naphthalate) (PEN); lyotropic liquid crystalline polymers formed by polycondensation of aromatic organic monomers to form aromatic polyesters, polyamides, aluminia-silicates, basalt, regenerated cellulosic materials and ultra-high molecular weight polyethylene (UHMWPE); and,
wherein the first polyolefin yarn and the second yarn are physically combined to form a composite yarn having at least one of the following properties: tenacity greater than about 100% of the expected tenacity based on the volume fraction of the second yarn; an initial modulus greater than about 100% of the expected modulus based on the volume fraction of the second yarn; elongation at break less than about 320% of the elongation at break of the second yarn.

20. The structure of claim 18 including a plurality of microfibrils included in at least one of the filaments of the first polyolefin yarn wherein the filament includes a plurality of voids interspersed within the microfibrils, wherein both said microfibrils and voids are aligned substantially parallel to the longitudinal axis of the first polyolefin yarn.
